(19) United States
(12) Patent Application Publication
(10) Pub. No.: US 2026/0234393 A1
(43) Pub. Date: Aug. 13, 2026

(54) ENVIRONMENTALLY FRIENDLY BIAXIALLY-ORIENTED ULTRA-HEAT SEALABLE POLYESTER FILM AND PROCESS OF ITS PREPARATION

(71) Applicant: ESTER INDUSTRIES LIMITED, Khatima (IN)

(72) Inventors: Balasundaram DILLYRAJ, Khatima (IN); Chandrakant Omkar VYAS, Khatima (IN); Gokal KUMAR, Khatima (IN); F. Louis JOSEPH, Khatima (IN); Girish BEHAL, Gurugram (IN); Shailendra YADAV, Gurugram (IN); Gaurav OJHA, Khatima (IN); Vinod Singh KANYAL, Khatima (IN); Saroj KUMAR, Khatima (IN)

(21) Appl. No.: 18/880,659

(22) PCT Filed: Feb. 8, 2024
(86) PCT No.: PCT/IN2024/050126

§ 371 Date: Jan. 2, 2025

(30) Foreign Application Priority Data
Feb. 8, 2023 (IN) 202311008051

(51) Int. Cl. C08L 67/02; B32B 27/08; B32B 27/30; B32B 27/36

(52) U.S. Cl. CPC C08L 67/02; B32B 27/08; B32B 27/306; B32B 27/36; B32B 2250/24; B32B 2305/70; B32B 2307/31; B32B 2307/518; B32B 2307/54; B32B 2307/581; B32B 2307/7244; B32B 2307/7376

(57) ABSTRACT

A biaxially-oriented ultra-heat sealable polyester film includes: a core layer comprising polyethylene terephthalate, post-consumer recycled grade polyethylene terephthalate, and a filler; and a heat-sealable layer disposed on at least one surface of the core layer and comprising a co-polyester composition; wherein: the co-polyester composition of the heat-sealable layer comprises: terephthalic acid, dimethyl terephthalate or a combination thereof, at least one diol selected from the group consisting of mono ethylene glycol, diethylene glycol, triethylene glycol, 1,3-propanediol, 1,4-butanediol, neopentyl glycol, hexamethylene glycol, and cyclohexanedimethanol; and isophthalic acid; wherein the biaxially-oriented ultra-heat sealable polyester film exhibits a seal strength greater than 800 gmf/inch when sealed at 140° C. for 1 second at 4 kg/cm² of pressure.

### CROSS-REFERENCE TO RELATED APPLICATIONS

This application is the U.S. national stage of International Patent Application No. PCT/IN2024/050126, filed Feb. 8, 2024 which claims the benefit of priority to Indian Patent Application number 202311008051, filed on Feb. 8, 2023, the entire disclosure of which is incorporated herein by reference for any and all purposes.

### FIELD

The present disclosure relates to compositions and methods of manufacturing environmentally friendly, ultra-heat sealable, biaxially-oriented ultra-heat sealable polyester films or laminates having seal through contamination, low temperature sealing and high seal strength. The present disclosure also relates to heat-sealable co-polyesters for producing the ultra-heat-sealable biaxially-oriented ultra-heat sealable polyester films and use of the films as packaging materials.

### BACKGROUND

It is well known that manufacturing polymers from recycled content consumes approximately 70% less energy and emits less greenhouse gases, significantly reducing the environmental impact of these types of food packaging. But historically, the recycling rates for films have been problematic because these materials are often multilayer or include more diversity and are more challenging to collect than other food packaging such as glass, aluminum, and steel. United nations have adopted 17 sustainable goals, one of which is climate change. To work in favor of climate and better environment, manufacturers of multilayer flexible food packaging are under the burden of redesigning the packaging material in a way that it can be recycled.

Multi-material multilayer structures/packages consist of more than one layer of distinct materials where the components are layered to form flexible packaging (pouches, bags, shrink films, other pliable products) or rigid ones (trays, cups, containers, other rigid plastic sheets). This type of packaging is widely applied in the FMCG (Fast Moving Consumer Goods) industry, in items with a relatively low-cost price and with a relative short lifespan, like beverages, food, and toiletries. Packaging for fresh food products may consist of four to seven layers of different components. A wide range of substances with different physical and chemical characteristics form multi-material multilayers. Various polymers are applied, such as polyolefin's PE (polyethylene) and PP (polypropylene) and their chemical variants HDPE (high density polyethylene), LDPE (low density polyethylene), LLDPE (linear low-density polyethylene), OPP (oriented polypropylene) and CPP (cast polypropylene), or polyesters such as PET (polyethylene terephthalate) and PBT (polybutylene terephthalate). These multilayer multi-material films and sheets are developed by co-extrusion or lamination techniques. In multi-material multilayer packaging, the use of different materials in different layers is connected to functionalities and packaging performance needs. As protecting the goods from abrasion, moisture, oxygen, light, odor, flavor, and chemicals is essential for packaging performance, an effective flexible barrier packaging solutions are needed to achieve these goals.

Replacing multiple layer flexible barrier packaging is challenging because only a limited number of barriers are available. Thus, the environmentally friendly ultra-heat-sealable, biaxially-oriented, polyester film produced in the present invention would serve a solution for most of the problems associated with packaging industry.

### SUMMARY

Embodiments described herein relate generally to biaxially-oriented ultra-heat sealable polyester films or laminates. In one aspect, provided are biaxially-oriented ultra-heat sealable polyester films which include a core layer and a heat-sealable layer. In some embodiments, the core layer includes polyethylene terephthalate, post-consumer recycled grade polyethylene terephthalate, and a filler. In other embodiments, the heat-sealable layer is disposed on at least one surface of the core layer and includes a co-polyester composition. In some embodiments, the co-polyester composition of the heat-sealable layer includes (a) terephthalic acid, dimethyl terephthalate or a combination thereof; (b) at least one diol selected from the group consisting of mono ethylene glycol, diethylene glycol, triethylene glycol, 1,3-propanediol, 1,4-butanediol, neopentyl glycol, hexamethylene glycol, and cyclohexanedimethanol; and (c) isophthalic acid. In some embodiments, the biaxially-oriented ultra-heat sealable polyester film exhibits a seal strength greater than 800 gmf/inch when sealed at 140° C. for 1 second at 4 kg/cm² of pressure.

In some embodiments, the biaxially-oriented ultra-heat sealable polyester film of the present technology has at least two layers. In another embodiment, the heat-sealable co-polyester includes (a) 35 to 75% by weight of terephthalic acid, dimethyl terephthalate or a combination thereof; (b) 25 to 40% by weight of at least one diol selected from the group consisting of mono ethylene glycol, diethylene glycol, triethylene glycol, 1,3-propanediol, 1,4-butanediol, neopentyl glycol, hexamethylene glycol, and cyclohexanedimethanol; and (c) 10 to 30% by weight of isophthalic acid. In yet other embodiment, the core layer mixture includes 40 to 80% by weight of polyethylene terephthalate polyester; 0 to 30% by weight of modified polyethylene terephthalate polyester which is a fiber-grade polyester; 20 to 100% by weight of post-consumer recycled polyethylene terephthalate; and 0.05 to 0.1% by weight of silica. In some embodiments, the polyethylene terephthalate polyester of the core layer mixture includes about 70 to 80% by weight of terephthalic acid, about 22 to 30% by weight of mono ethylene glycol, and about 0.5 to 5% by weight of diethylene glycol. In other embodiments, the fiber-grade polyester of the core layer mixture includes about 68 to 85% by weight of terephthalic acid, about 20 to 30% by weight of mono ethylene glycol, and about 2 to 10% by weight of diethylene glycol.

In some embodiments, the biaxially-oriented ultra-heat sealable polyester film of the present technology has a total thickness of from about 15 μm to about 50 μm, wherein the core layer makes up from about 50% to about 80% of the total thickness of the film. In other embodiments, the biaxially-oriented ultra-heat sealable polyester film of the present technology has one of more of: a seal strength of about 800 gmf/inch to about 4500 gmf/inch when sealed at 140° C. for 1 second at 4 kg/cm² of pressure; a total thickness of about 15 μm to about 50 μm, wherein the core layer makes up from about 50% to about 80% of the total thickness of the film; a shrinkage, measured according to ASTM D1204, of about 2% or less in each of longitudinal and width directions after treatment with hot air at 150° C. for 30 min; a puncture resistance, measured according to ASTM F1306 of about 5.5 N or greater; a tensile strength at break, measured according to ASTM D882, of about 1300 kg/cm² to about 1900 kg/cm²; and an elongation at break, measured according to ASTM D882, of about 100 kg/cm² to about 160 kg/cm². In some embodiments, the biaxially-oriented ultra-heat sealable polyester film has water vapor transmission rate in the range of 0.30 to 45 g/m²-day, and oxygen transfer rate in the range of 0.40 to 100 cc/m²-day.

In some embodiments, the biaxially-oriented ultra-heat sealable polyester film of the present technology further includes one or more additional layer selected from a sealant layer, a printing layer, a metal layer, a barrier layer, an adhesive layer, a coating layer, a primer layer, and a protective layer.

In another aspect, multilayer high-barrier films are provided, which include the biaxially-oriented ultra-heat sealable polyester film of the present technology. In some embodiments of the multilayer films, a barrier layer disposed on at least one of the one or more of the core layers. In some embodiments, the barrier layer includes at least one of ethylene vinyl alcohol copolymers, polyvinyl alcohol polymers and copolymers, or polyvinylidene dichloride, aluminum, silicon oxide, and aluminum oxide; In some embodiments, the multilayer high-barrier film is unprinted or reverse-printed. In some embodiments, the multilayer high-barrier film has water vapor transmission rate in the range of 0.30 to 0.40 g/m²-day, and oxygen transfer rate in the range of 0.40 to 0.50 cc/m²-day. In one aspect, biaxially oriented ultra-heat sealable polyester film or the multilayer high-barrier film are provided for use in pouches or overwrap packaging.

In one aspect, co-polyester compositions are provided, which include a first polymer composition including pure terephthalic acid, ethylene glycol, and isophthalic acid; and a second polymer composition including pure terephthalic acid, ethylene glycol, and neopentyl glycol. In some embodiments, the weight ratio of the first polymer composition to the second polymer composition is in the range of about 70:30.

Embodiments described herein relate generally to processes for providing an environmentally friendly ultra-heat-sealable, biaxially-oriented, polyester film having seal through contamination, low temperature sealing and high seal strength. In one aspect, a process for preparing a biaxially-oriented polyethylene terephthalate ultra-heat-sealable film is provided. The process includes preparing a core layer mixture comprising polyethylene terephthalate, modified polyethylene terephthalate, post-consumer recycled polyester and a filler, wherein the modified polyethylene terephthalate comprises fiber-grade polyester; preparing a heat-sealable layer mixture comprising a heat-sealable co-polyester; charging the core layer mixture to a main extruder to obtain a molten first mixture; charging the heat-sealable layer mixture to a sub-extruder to obtain a molten second mixture; extruding the molten first mixture and the molten second mixture through a die to provide an unstretched film; and biaxially stretching the unstretched film under preheating conditions and heat-treating said film to a temperature of from about 250° C. to about 290° C., such that the stretch ratio in the longitudinal direction is from about 3 to about 3.6 times based on the original length of the unstretched film, and the stretch ratio in the transverse direction is from about 3.2 to about 4.5 times based on the original width of the unstretched film; cooling the stretched film to obtain a biaxially-oriented ultra-heat-sealable polyethylene terephthalate film; wherein a heat-sealing temperature of the biaxially-oriented ultra-heat-sealable polyethylene terephthalate film is about 100° C. to about 200° C. In some embodiments, the biaxially-oriented ultra-heat-sealable polyester film of the present technology has at least two layers.

In some embodiments, the preparation of a heat-sealable layer mixture includes charging in a reactor terephthalic acid, dimethyl terephthalate or a combination thereof with at least one diol and isophthalic acid to obtain a reaction mixture; subjecting the reaction mixture to an esterification reaction at a temperature of about 240° C. to about 270° C. to obtain an esterified prepolymer; charging the esterified prepolymer to a polycondensation reactor and adding one or more polycondensation catalyst selected from silica, antimony compounds and magnesium compounds; subjecting the prepolymer to a polycondensation reaction at a temperature in the range of about 270° C. to about 310° C. to obtain a molten amorphous polymer; cooling and processing the molten polymer to form chips or pellets; and optionally subjecting the resultant chips to solid state polymerization, to obtain a heat-sealable layer mixture comprising a heat-sealable co-polyester having an intrinsic viscosity greater than 0.65 dL/g.

In some embodiments of the process of present technology, the heat-sealable co-polyester includes about 35 to about 70% by weight of terephthalic acid, dimethyl terephthalate, or a combination thereof; about 21 wt. % to about 40 wt. % of mono ethylene glycol, diethylene glycol, triethylene glycol, 1,3-propanediol, 1,4-butanediol, neopentyl glycol, hexamethylene glycol, cyclohexanedimethanol, or a mixture of any two or more thereof; and about 10 wt. % to about 30 wt. % isophthalic acid. In some embodiments of the process of present technology, the core layer mixture includes about 40 wt. % to about 80 wt. % polyethylene terephthalate polyester; about 0 wt. % to about 30 wt. % fiber-grade polyester; about 20 wt. % to about 100 wt. % post-consumer recycled polyethylene terephthalate; and about 0.05 wt. % to about 0.1 wt. % silica. In some embodiments of the process of present technology, the polyethylene terephthalate polyester of the core layer mixture includes about 70 wt. % to about 85 wt. % terephthalic acid, about 20 wt. % to about 30 wt. % mono ethylene glycol, and about 0.5 wt. % to about 5 wt. % diethylene glycol. In some embodiments of the process of present technology, the fiber-grade polyester of the core layer mixture includes about 65 wt. % to about 85 wt. % terephthalic acid, about 20 wt. % to about 30 wt. % mono ethylene glycol, and about 2 wt. % to 10 wt. % diethylene glycol.

In some embodiments of the process of present technology, the process further includes passing the molten first mixture and the molten second mixture through a filter. In some embodiments, the process further includes laminating the molten first mixture and the molten second mixture together in a feed-block to produce a laminated molten structure in the extrusion die.

In some embodiments of the process of present technology, the processing step includes subjecting the extruded structure to one or more steps of preheating, stretching, and cooling. In some embodiments, the stretching is conducted sequentially or simultaneously in the machine direction and the transverse direction. In some embodiments, the preheating, stretching and cooling includes machine direction preheating, stretching, and cooling followed by transverse direction preheating, stretching, and cooling. In some embodiments, the preheating conditions include passing the unstretched film through a machine direction preheating zone at a temperature of about 70° C. to about 90° C., stretching the preheated structure in a longitudinal direction, and passing the longitudinally stretched film through a machine direction cooling zone at a temperature of about 70° C. to about 90° C.

In some embodiments of the process of present technology, the process further includes passing the cooled longitudinally stretched film through a transverse direction preheating zone at a temperature of about 92° C. to about 110° C., stretching the preheated film in a transverse direction, and passing the transversely stretched film through a machine direction cooling zone at a temperature of about 60° C. to about 85° C. In some embodiments of the process of present technology, the process further includes adding an additional layer to the biaxially-oriented ultra-heat sealable polyester film. In some embodiments, the additional layer includes one or more of a sealant layer, a printing layer, a metal layer, a barrier layer, an adhesive layer, a coating layer, a primer layer, and a protective layer.

In another aspect, provided are packaging materials which include the biaxially-oriented ultra-heat sealable polyester film of the present technology. In yet another aspect, provided are packaging materials which include the biaxially-oriented ultra-heat sealable polyester film produced by the process of the present technology. In some embodiments, the films include food grade packaging films or medical products packaging films.

In another aspect, provided is a process for preparation of heat-sealable co-polyester compositions which are used in preparation of films of the present technology. In some embodiments the process for preparation of heat-sealable co-polyester compositions includes charging in a reactor terephthalic acid, dimethyl terephthalate or a combination thereof with at least one diol and isophthalic acid to obtain a reaction mixture; subjecting the reaction mixture to an esterification reaction at a temperature of about 240° C. to about 270° C. to obtain an esterified prepolymer; charging the prepolymer to a polycondensation reactor and adding one or more polycondensation catalyst selected from silica, antimony compounds and magnesium compounds; subjecting the prepolymer to a polycondensation reaction at a temperature in the range of about 270° C. to about 310° C. to obtain a molten amorphous polymer; crystallizing the amorphous polymer at a temperature in the range of about 110° C. to about 170° C. to obtain chips or pellets with a crystallinity of about 40% or more; and optionally subjecting the chips or pellets to solid state polymerization, to obtain a heat-sealable layer mixture comprising a heat-sealable co-polyester having an intrinsic viscosity greater than 0.65 dL/g. In some embodiments of the process, the co-polyester composition includes a first polymer composition comprising pure terephthalic acid, ethylene glycol, and isophthalic acid, and a second polymer composition comprising pure terephthalic acid, ethylene glycol, and neopentyl glycol, wherein the weight ratio of the first polymer composition to the second polymer composition is in the range of about 70:30.

It should be appreciated that all combinations of the foregoing concepts and additional concepts discussed in greater detail below (provided such concepts are not mutually inconsistent) are contemplated as being part of the subject matter disclosed herein. All combinations of claimed subject matter appearing at the end of this disclosure are contemplated as being part of the subject matter disclosed herein.

### DESCRIPTION OF DRAWINGS

FIG. 1 is a flow chart for the manufacturing process of a biaxially-oriented ultra-heat sealable polyester film, according to an embodiment of the present technology.

FIG. 2 is an illustration of a packaging material having a single layer surface printed flexible recyclable PET film, according to an embodiment of the present technology.

FIG. 3 is an illustration of a packaging material having a single layer surface metalized flexible recyclable PET film, according to an embodiment of the present technology.

FIG. 4 is an illustration of a packaging material having a multilayer reverse printed or unprinted, flexible recyclable PET film, according to an embodiment of the present technology.

FIG. 5 is an illustration of a packaging material having a multilayer, high barrier coated, reverse printed or unprinted, flexible recyclable PET film, according to an embodiment of the present technology.

FIG. 6 is an illustration of a packaging material having a multilayer, ultra-high barrier coated, reverse printed or unprinted, flexible recyclable PET film, according to an embodiment of the present technology.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

For convenience, before further description of the present invention, certain terms employed in the specification, examples and appended claims are collected here. These definitions should be read in light of the remainder of the disclosure and understood as by a person of skill in the art. Unless defined otherwise, all technical and scientific terms used herein have the same meaning as commonly understood by a person of ordinary skill in the art.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The term “including” is used to mean “including but not limited to.” “Including” and “including but not limited to” are used interchangeably.

The term “polyester” generally refers to an esterification or reaction product between a polybasic organic acid and a polyol. The present disclosure is particularly directed to a class of polyesters referred to herein as polyethylene terephthalate, in which terephthalic acid serves as the polybasic organic acid, and particularly to PET, but it should be understood that the disclosure is not in any way limited to PET. It covers all polyesters viz PET, PBT, PTT and their allied copolyesters blends and alloys.

The term “co-polymer” as used herein, refers to blends of PET with PBT/PTT in any desired ratio.

The terms “core layer” or “outer layer,” as used herein is a relative term and need not be a surface layer. Rather, these terms refer to a layer comprising the outer surface of a film or product or alternatively the core surface of a laminated film or product.

The terms “heat-sealable layer” and “sealant layer” are used interchangeably to represent the “inner layer,” which refers to a layer comprising the inner surface of a film or product. For example, an inner layer forms the interior surface of an packaging which may be adjacent to or in contact with the product being packaged.

The term “ultra-heat sealable” as used herein refers to a polymeric material which can be sealed to itself or to another material by the application of heat and pressure.

The term “high barrier” as used herein represents materials that have undergone the barrier coating process, exhibits superior resistance compared to standard or untreated materials. This heightened barrier capability makes the coated material suitable for use in MAP (Modified Atmosphere Packaging) applications where stringent protective measures are required, including, but not limited to food packaging, pharmaceuticals, or electronic components.

The term “ultra-high barrier” as used herein refers to metallized films or laminates that offers superior performance compared to standard metallized films or non-metallized films. This heightened barrier capability is particularly valuable in applications where the preservation of the packaged contents requires an exceptionally robust protective barrier. Industries such as food packaging, pharmaceuticals, and electronics, where maintaining product integrity is critical, often utilize ultra-high barrier materials to ensure an extended shelf life and optimal quality of the packaged items.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, 5 to 40 mole % should be interpreted to include not only the explicitly recited limits of 5 to 40 mole %, but also to include sub-ranges, such as 10 mole % to 30 mole %, 7 mole % to 25 mole %, and so forth, as well as individual amounts, including fractional amounts, within the specified ranges, such as 15.5 mole %, 29.1 mole %, and 12.9 mole %, for example.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

In one aspect, an environmentally friendly, ultra-heat sealable, biaxially-oriented polyester films and laminates are provided, having reduced seal through contamination, low temperature sealing, and high seal strength. Ultra-high seal strength is a characteristic of a sealing process that results in an exceptionally strong and reliable bond between packaging materials, resulting from a combination of carefully selected materials, controlled sealing conditions, and appropriate sealant compositions. The films possess good mechanical strength, moisture, and oxygen barrier properties, excellent dimensional stability, easy process ability, good bag breakage resistance, and chemical resistance properties and can be easily recycled mechanically or chemically. Additionally, the films have good orientability and drawability, and have the capability of excellent longitudinal and transverse orientation during its production without break-off. These properties are achieved via a co-extruded biaxially-oriented polyester film that includes, among other components, polyethylene terephthalate (PET), post-consumer recycled PET, isophthalic acid (IPA), 2,2-dimethylpropane-1,3-diol (NPG), and, optionally, CHDM (cyclohexanedimethanol).

The biaxially-oriented ultra-heat sealable polyester films may have a monolayer structure having a single layer or a multilayered structure having at least two layers, including e.g., two layers, three layers, four layers, five layers, six layers, seven layers, eight layers, nine layers or ten layers. The biaxially-oriented ultra-heat sealable polyester film has an outer layer (core layer) and an inner layer (heat-sealable or sealant layer). The heat-sealable layer is disposed on at least one surface of the core layer. In the case of two layers, it may be layered core layer/heat-sealable layer, and in the case of three layers, it may be heat-sealable layer/core layer/heat-sealable layer, and so on and so forth.

The biaxially-oriented ultra-heat sealable polyester films may be manufactured in a varied range of thicknesses. The thickness of the biaxially-oriented ultra-heat sealable polyester film, e.g., when the film has a two-layer ultra-heat sealable film, may range from about 5 μm to about 60 μm, including from about 10 μm to about 55 μm, about 15 μm to about 50 μm, about 18 μm to about 45 μm, about 20 μm to about 40 μm, or about 25 μm to about 30 μm. In some embodiments, the ultra-heat sealable polyester film may be laminated, in which case the laminated film may have a thickness ranging from about 5 μm to about 100 μm, including from about 8 μm to about 90 μm, about 10 μm to about 80 μm, about 15 μm to about 75 μm, about 20 μm to about 70 μm, or about 25 μm to about 60 μm. In some embodiments, the biaxially-oriented ultra-heat sealable polyester film may have a total thickness of from about 15 μm to about 50 μm.

The core and heat-sealable layers may each have the same thickness or different thickness. The thickness of the heat-sealable layer may be from about 20% to about 40%, including from about 22% to about 38%, about 25% to about 35%, or about 28% to about 32%, of the total film thickness. For example, with respect to a 30 μm thick film, the heat-sealable layer thickness may be from about 9 to about 15 μm. The thickness of the outer layer may be from about 60% to about 80%, including from about 62% to about 78%, about 65% to about 75%, or about 68% to about 72%, of the total film thickness. For example, with respect to a 30 μm thick film, the outer layer thickness may be from about 15 to about 24 μm. In some embodiments, the biaxially-oriented ultra-heat sealable polyester film may have a total thickness of from about 15 μm to about 50 μm, wherein the core layer makes up from about 50% to about 80% of the total thickness of the film. In some embodiments, the thickness ratio of the core layer to the heat-sealable layer may be about 50:50, including from about 60:40, about 65:35, about 70:30, about 75:25, about 80:20 or about 85:15.

The inner layer is the heat-sealable or sealant layer of the film, which provides seal strength to the film. The sealant layer provides heat sealing of the film to itself or to another film or non-film layer, facilitating low temperature sealing and providing low seal through contamination of the films. Heat sealing can be achieved using one or more of a wide variety of sealing methods including, but not limited to, thermal sealing, hot air sealing, hot wire sealing, ultrasonic sealing, infrared radiation sealing, ultraviolet radiation sealing, electron beam sealing, melt-bead sealing, impulse sealing, and the like.

The inner layer, which is the heat-sealable or sealant layer is formed from a polyester composition, typically a co-polyester composition formed from a dicarboxylic acid-diol reaction. The co-polyester composition includes a dicarboxylic acid or a dicarboxylic ester, such as terephthalic acid (PTA) and/or dimethyl terephthalate (DMT). In some embodiments, the co-polyester composition includes a purified dicarboxylic acid and/or a purified dicarboxylic ester. In some embodiments, the co-polyester composition includes purified PTA and/or purified DMT as the main component. In some embodiments, the PTA and/or DMT, individually or in combination, constitutes about 20% to about 90% of the total weight of the co-polyester composition, including from about 25% to about 80%, about 30% to about 65%, about 35% to about 70%, about 40% to about 60%, or about 45% to about 55% of the total weight of the co-polyester composition.

The co-polyester composition of the heat-sealable layer may further include one or more secondary copolymerization components such as diols and additional dicarboxylic acids. Suitable additional dicarboxylic acids include, but are not limited to, isophthalic acid (IPA), adipic acid, sebacic acid, naphthalene dicarboxylic acid, 4,4-diphenyldicarboxylic acid, and derivatives thereof. In some embodiments, the additional dicarboxylic acid includes a purified dicarboxylic acid. In some embodiments, the additional dicarboxylic acid includes IPA or purified IPA. In some embodiments, the additional dicarboxylic acid constitutes about 1% to about 50% of the total weight of the co-polyester composition, including from about 5% to about 40%, about 10% to about 30%, about 15% to about 25%, or about 20% to about 25% of the total weight of the co-polyester composition.

The co-polyester composition of the heat-sealable layer may further include one or more diols. Suitable diols may include, but are not limited to, mono ethylene glycol/ethylene glycol (MEG/EG), diethylene glycol (DEG), triethylene glycol, 1,3-propanediol, 1,4-butanediol, neopentyl glycol (NPG), hexamethylene glycol, cyclohexanedimethanol, or a combination of any two or more thereof. Other glycols including polyoxyalkylene glycols such as polyethylene glycol and polypropylene glycol may also be added. In some embodiments, the co-polyester composition includes one or more diol selected from the group consisting of MEG, DEG, and NPG. In some embodiments, the one or more diols constitutes about from about 10 wt. % to 50 wt. %, including from about 20% to about 45%, about 25% to about 40%, or about 30% to about 35% of the total weight of the co-polyester composition.

The heat-sealable co-polyester may include, for example, (a) 35 to 75% by weight of terephthalic acid, dimethyl terephthalate or a combination thereof; (b) 25 to 40% by weight of at least one diol selected from the group consisting of mono ethylene glycol, diethylene glycol, triethylene glycol, 1,3-propanediol, 1,4-butanediol, neopentyl glycol, hexamethylene glycol, and cyclohexanedimethanol; and (c) 10 to 30% by weight of isophthalic acid.

The sealant layer may include a co-polyester of PTA or DMT along with IPA and one or more diols such as MEG and NPG. In some embodiments, based on a total weight of the co-polyester being 100 wt. %, the PTA or DMT content may be from about 30 wt. % to 70 wt. %, the diol content from about 20 wt. % to 65 wt. %, the content of isophthalic acid from about 5 wt. % to 35 wt. %, and the content of neopentyl glycol from about 0 wt. % to 10 wt. %. In some embodiments, the sealant layer (co-polyester) composition includes about 35 to about 60 wt. % of PTA or DMT, preferably PTA; about 25 to about 40 wt. % of mono ethylene glycol/ethylene glycol (MEG/EG), diethylene glycol (DEG) 1,3-propanediol, 1,4-butanediol neopentyl glycol, or a mixture of any two or more thereof, preferably where the glycol is MEG, DEG, neopentyl glycol, or a mixture of two or more thereof; about 10 to about 30 wt. % IPA; and about 1 to about 5 wt. % NPG.

In some embodiments, provided is a co-polyester composition which includes a first polymer composition comprising pure terephthalic acid, ethylene glycol, and isophthalic acid; and a second polymer composition comprising pure terephthalic acid, ethylene glycol, and neopentyl glycol; wherein the weight ratio of the first polymer composition to the second polymer composition is in the range of about 70:30.

The outer layer may be the core layer of the film, which provides structural strength to the film. Along with the inner layer, the outer layer provides films that have good mechanical strength, moisture and oxygen barrier properties, excellent dimensional stability, easy processability, good bag breakage resistance and chemical resistance properties. The films are also easy to recycle mechanically or chemically.

The outer layer, which is the core layer, may include a variety of thermoplastic materials, e.g., PET materials. The thermoplastic materials can be used in various available forms, including, but are not limited to powder, pellets, chips, granules, flakes, pieces, beads, cylinders, rods, fluff, dust, and the like or combinations thereof. In some embodiments, the outer layer includes one or more of a virgin thermoplastic, a recycled thermoplastic, and a thermoformable grade thermoplastic. In some embodiments, the outer layer includes one or more of a virgin polyester material, a recycled polyester material, and a thermoformable grade polyester material. In some embodiments, the virgin polyester includes virgin PET as the major component. In some embodiments, the recycled polyester includes post-consumer recycled PET as the main component. In some embodiments, the thermoformable grade polyester includes thermoformable grade PET as the main component. In some embodiments, the outer layer composition includes one or more of a PET (polyethylene terephthalate) polyester, a FGT (thermoformable grade) polyester, and PCR (post-consumer recycled) PET.

In some embodiments, the outer layer includes virgin PET. In some embodiments, the virgin PET constitutes about 20 wt. % to about 90 wt. % of the outer layer composition, including from about 25 wt. % to about 80 wt. %, about 30 wt. % to about 70 wt. %, about 35 wt. % to about 65 wt. %, about 40 wt. % to about 60 wt. %, or about 45% to about 55% of the total weight of the co-polyester composition. The virgin PET may be formed from PTA and one or more diols such as EG and DEG. In some embodiments, based on a total weight of the virgin PET being 100 wt. %, the PTA content may be from about 40 wt. % to 80 wt. %, the EG content may be from about 10 wt. % to 40 wt. %, and the content of DEG may be from about 0 wt. % to 10 wt. %.

The outer layer composition may further include one or more thermoformable grade polyester materials, such as thermoformable grade PET. In some embodiments, the thermoformable grade PET constitutes about 5 wt. % to about 50 wt. % of the outer layer composition, including from about 5 wt. % to about 40 wt. %, about 10 wt. % to about 30 wt. %, about 15 wt. % to about 25 wt. %, or about 20 wt. % to about 25 wt. %, of the outer layer composition. The thermoformable grade PET may be formed from PTA and one or more diols such as EG and DEG. In some embodiments, based on a total weight of the thermoformable grade PET being 100 wt. %, the PTA content may be from about 40 wt. % to 80 wt. %, the EG content may be from about 10 wt. % to 40 wt. %, and the content of DEG may be from about 2 wt. % to 15 wt. %.

The outer layer composition further includes post-consumer recycled PET. In some embodiments, the PCR PET constitutes about 5 wt. % to about 60 wt. % of the outer layer composition, including from about 10 wt. % to about 50 wt. %, about 15 wt. % to about 45 wt. %, about 20 wt. % to about 40 wt. %, about 15 wt. % to about 30 wt. %, or about 20 wt. % to about 25 wt. %, of the outer layer composition. In some embodiments, the outer layer of the film may include 100 wt. % PCR PET. In another embodiment, the outer layer of the film may include less than 100 wt. %, less than 99 wt. %, less than 95 wt. %, less than 90 wt. %, less than 80 wt. %, less than 70 wt. %, or less than 60 wt. % PCR PET. In yet another embodiment, the outer layer of the film may include greater that 5 wt. %, greater than 10 wt. %, greater than 15 wt. %, greater that 20 wt. %, greater than 30 wt. %, greater than 40 wt. % or greater that 50 wt. % PCR PET. In another embodiment, the amount of PCR PET in the entire film may range from about 10 wt. % to about 90 wt. %, about 20 wt. % to about 80 wt. %, about 25 wt. % to about 75 wt. %, or about 30 wt. % to about 60 wt. %, of the total composition.

The outer layer may further include a plurality of filler materials. Suitable filler materials may include, but are not limited to, silicon dioxide, titanium dioxide, cerium dioxide, aluminum hydroxide, magnesium hydroxide, aluminum oxide, magnesium oxide, boron oxide, calcium oxide, calcium carbonate, barium carbonate, lithium phosphate, calcium phosphate, magnesium phosphate, calcium sulfate, barium sulfate, talc, clay, or a combination of any two or more thereof. In some embodiments, the filler material includes or is silicon dioxide (silica). In some embodiments, based on a total weight of the outer layer being 100 wt. %, the filler material content may be present from about 0 wt. % to 10 wt. %, including from about 0.0001 wt. % to about 5 wt. %, about 0.01 wt. % to about 4 wt. %, about 0.075 wt. % to about 3 wt. %, about 0.05 wt. % to about 2 wt. %, or about 0.1 wt. % to about 1 wt. % of the outer layer composition. In some embodiments, the amount of silicon dioxide may be from about 250 ppm to about 2000 ppm, including from about 500 ppm to about 1500 ppm, or about 750 ppm to about 1000 ppm.

In some embodiments, the outer layer (core) composition may include about 40 wt. % to about 60 wt. % of a polyester where the polyester includes PET (73.5 wt. % PTA, 25 wt. % EG, and 1.5 wt. % DEG); about 10 wt. % to about 30 wt. % of FGT polyester, where the FGT polyester (71 wt. % PTA, 23 wt. % EG, and 6.0 wt. % DEG); and about 20 wt. % to about 40 wt. % of post-consumer recycled PET chips.

In some embodiments, the core layer mixture may include, for example, 40 to 80% by weight of polyethylene terephthalate polyester; about 0 to about 30% by weight of modified polyethylene terephthalate polyester which is a fiber-grade polyester; about 20 to about 100% by weight of post-consumer recycled polyethylene terephthalate; and about 0.05 to about 0.1% by weight of silica. In some embodiments, the polyethylene terephthalate polyester of the core layer mixture includes about 70 to 80% by weight of terephthalic acid, about 22 to 30% by weight of mono ethylene glycol, and about 0.5 to 5% by weight of diethylene glycol. In some embodiments, the fiber-grade polyester of the core layer mixture includes about 68 to 85% by weight of terephthalic acid, about 20 to 30% by weight of mono ethylene glycol, and about 2 to 10% by weight of diethylene glycol.

The PET materials of the inner and/or outer layer may also include other inorganic residues. Examples of such inorganic residues may include, but are not limited to, alkaline earth metal salts, alkali salts, including calcium, magnesium, sodium and potassium salts, antimony-containing compounds, germanium-containing compounds, titanium-containing compounds, cobalt-containing compounds, tin containing compounds, aluminum, aluminum salts, phosphorous-containing compounds and anions, sulfur-containing compounds and anions, and the like or combinations thereof. The total amount of such inorganic residues may be from about 0 ppm to 1000 ppm including from about 5 to 800 ppm, about 10 to 700 ppm, about 50 to 500 ppm, or about 100 to 250 ppm.

The biaxially-oriented ultra-heat sealable polyester films of the present technology are environmentally friendly, and have reduced seal through contamination, low temperature sealing, and high seal strength. For example, the films utilize a higher percentage of PCR chips will are beneficial in reducing the CO₂ footprint. In some embodiments, the films of the present technology have a seal strength of greater than about 500 gmf/inch (grams-force per square inch), preferably greater than about 800 gmf/inch. In some embodiments, the films of the present technology have a seal strength of about 800 gmf/inch to about 4500 gmf/inch, about 900 gmf/inch to about 4300 gmf/inch, about 1000 gmf/inch to about 4000 gmf/inch, or about 1100 gmf/inch to about 3800 gmf/inch, when sealed at 140° C. for 1 second at 4 kg/cm² of pressure.

The biaxially-oriented ultra-heat sealable polyester films of the present technology may have a shrinkage, measured according to ASTM D1204, of about 5% or less, about 4% or less, about 3% or less, about 2% or less, about 1.5% or less or about 1% or less in each of longitudinal and width directions after treatment with hot air at 150° C. for 30 min.

The biaxially-oriented ultra-heat sealable polyester films may exhibit a puncture resistance, measured according to ASTM F1306, of about 5.0 N or greater, including about 5.5 N or greater, about 6.0 N or greater, or about 6.5 or greater, and about 7.5 N or lower including about 7.0 N or lower, or about 6.5 or lower. The biaxially-oriented ultra-heat sealable polyester films may exhibit a puncture resistance of about 5.5 N to about 7.0 N. In some embodiments, the biaxially-oriented ultra-heat sealable polyester films exhibit a puncture resistance, measured according to ASTM F1306, of about 5.5 N or greater.

The biaxially-oriented ultra-heat sealable polyester films of the present technology may have a tensile strength at break, measured according to ASTM D882, of about 1000 kg/cm² to about 2500 kg/cm², including about 1200 kg/cm² to about 2200 kg/cm², about 1300 kg/cm² to about 1900 kg/cm², or about 1500 kg/cm² to about 1800 kg/cm². In some embodiments, the biaxially-oriented ultra-heat sealable polyester films of the present technology may have a tensile strength at break, measured according to ASTM D882, of about 1300 kg/cm² to about 1900 kg/cm².

The biaxially-oriented ultra-heat sealable polyester films of the present technology may have an elongation at break, measured according to ASTM D882, of about 80 kg/cm² to about 220 kg/cm², including about 90 kg/cm² to about 200 kg/cm², about 100 kg/cm² to about 160 kg/cm², or about 120 kg/cm² to about 160 kg/cm². In some embodiments, the biaxially-oriented ultra-heat sealable polyester films of the present technology may have an elongation at break, measured according to ASTM D882, of about 100 kg/cm² to about 160 kg/cm². In some embodiments, the films may exhibit an elongation of about 140% or greater, including about 100% or greater, about 120% or greater, about 140% or greater, about 160% or greater, about 180% or greater, about 190% or greater, about 200% or greater.

The biaxially-oriented ultra-heat sealable polyester films of the present technology may have a water vapor transmission rate in the range of about 0.10 to 50 g/m²-day, including about 0.30 to 45 g/m²-day, about 0.50 to 40 g/m²-day, or about 0.80 to 35 g/m²-day. The biaxially-oriented ultra-heat sealable polyester films of the present technology may have an oxygen transfer rate in the range of about 0.20 to 150 cc/m²-day, including about 0.30 to 125 cc/m²-day, about 0.40 to 100 cc/m²-day, about 0.50 to 80 cc/m²-day or 0.80 to 60 cc/m²-day. In some embodiments, the biaxially-oriented ultra-heat sealable polyester films of the present technology may have water vapor transmission rate in the range of 0.30 to 45 g/m²-day, and oxygen transfer rate in the range of 0.40 to 100 cc/m²-day.

In another aspect, a method for manufacturing the ultra-heat sealable biaxially-oriented films is provided. In some embodiments, an ultra-heat sealable, biaxially-oriented polyester film can be prepared using a conventional sequential biaxial orientation machine having a single screw mainline extrusion and a twin-screw sub extrusion process. For example, PET and modified PET pellets in combination with silica can be fed into the main extrusion line, while a blend of copolymerized PET pellets can be fed into the sub-extruder. The materials can be co-extruded or they can be melted separately and then laminated together in a feed block to produce a molten structure in an extrusion die. The laminated molten structure, e.g., a PET sheet extruded from slit die, can then be quenched with the help of chilled casting drum to produce a thick and amorphous film. The amorphous film can be subsequently stretched in the longitudinal direction (MD) or in length direction axis of the film, utilizing a motorized heater roller train at a suitable temperature range. The stretching can be conducted in a system having a main extrusion line and a sub-extrusion line, such that the main extrusion line mixture and sub-extruder mixture are extruded through a die to shape, form, or extrude the BOPET material into the desired configuration. Tailored to the specific requirements of BOPET film production, the die ensures uniformity and precision in the final product. The die design allows for the creation of intricate and consistent shapes with high repeatability. Casting of the extrudate is a manufacturing technique employed to shape and solidify molten BOPET material into a desired form. In this process, molten material is carefully passed through, where it solidifies to assume the intended shape. Casting proves particularly useful for creating complex parts with intricate details, contributing to the flexibility and adaptability of the BOPET film manufacturing process. In some embodiments, uneven webbing carries out cutting edge process by not stretching and stretching. In some embodiments, a thin layer of metal is deposited onto the film substrate to create a high-moisture and oxygen barrier. The processed BOPET film is cut into finished product as per the required specifications or requirement.

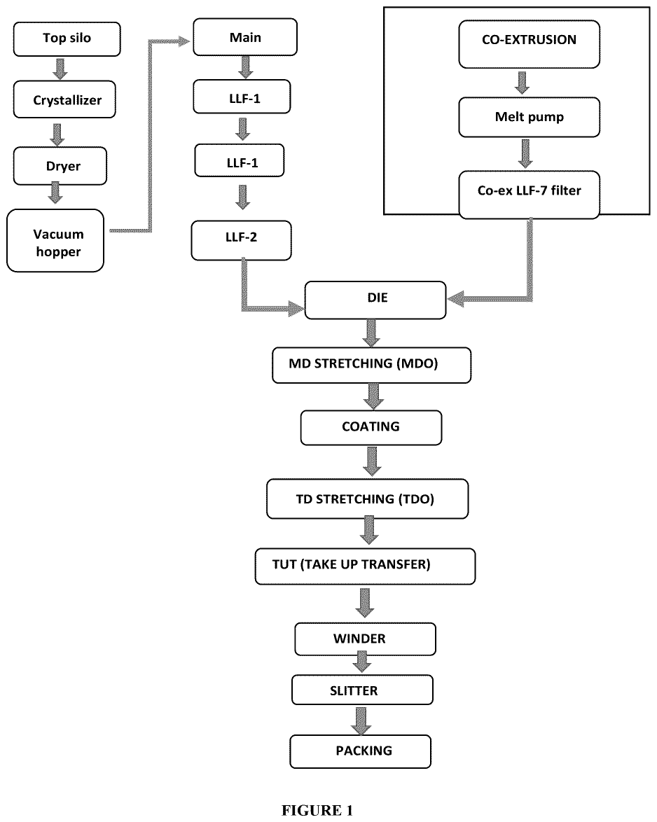

Referring to the process flow diagram of FIG. 1, a method is provided for producing a biaxially-oriented polyester film. The method for producing the biaxial stretched polyester film can be carried out using a conventional sequential biaxial orientation machine having a mainline extrusion and sub-extrusion (co-extrusion) process. PET chips were prepared to be fed into the main extrusion line. The PET chips may be prepared by subjecting them to crystallization using a crystallizer to induce controlled crystallinity in molten PET during the manufacturing process. A crystallinity of about 40% to about 50%, or more can be targeted. This controlled crystallization promotes the formation of a structured crystalline matrix within the polymer. The crystallization temperature may be from about 120° C. to about 200° C., including from about 150° C. to about 180° C., about 160° C. to about 175° C., or about 160° C. to about 170° C. The result is an enhancement of the film's mechanical strength, dimensional stability, and barrier properties.

Following the crystallization process, the PET chips are dried in a dryer to eliminate residual moisture. The dryer may utilize hot air to efficiently evaporate the water content, ensuring that the finish product attains the desired moisture level. The crystallization temperature may be from about 130° C. to about 200° C., including from about 150° C. to about 180° C., about 160° C. to about 175° C., or about 165° C. to about 170° C. The drying step may be conducted for a suitable time until the desired moisture levels are achieved. For example, the drying may be conducted so that the moisture is reduced down from about 2000 ppm to about 40 to 60 ppm. This step aids in achieving uniform film quality, physical properties, and optical clarity.

The dried PET chips are introduced into a vacuum hopper, which facilitates controlled feeding and metering of PET resin into the main extruder. Applying a vacuum to the hopper ensures a consistent and uniform flow of the polymer material, thereby providing consistent film thickness and properties. The PET from the hopper, thermoformable grade PET pellets, and postconsumer recycled polyester chips, optionally in combination with a filler having desired properties, are fed into the main extrusion line at a suitable temperature to obtain a first mixture. The melt temperature in the main extrusion line may be from about 150° C. to about 350° C., including from about 180° C. to about 320° C., about 200° C. to about 310° C., about 230° C. to about 300° C., or about 255° C. to about 280° C.

The co-extrusion or sub-extrusion line is fed the contents of the inner layer that is the co-polyester of PET layer and IPA, NPG, and/or CHDM into the process at a suitable temperature to obtain a second mixture. The melt temperature in the co-extrusion line may be from about 150° C. to about 350° C., including from about 180° C. to about 320° C., 200° C. to about 310° C., 250° C. to about 300° C., or 260° C. to about 280° C.

The extrusion process allows the materials to melt separately, following which the molten first mixture polymer passes through a filter, which aids in refining and purifying raw materials or fluids used in the manufacturing process. By effectively removing impurities and contaminants, the filter ensures the integrity of the final BOPET film. This enhances the film's quality by preventing defects and maintaining consistent material composition. Thus, in some embodiments, the process of the present technology further includes passing the molten first mixture and the molten second mixture through a filter. In other embodiments, the process of the present technology further includes laminating the molten first mixture and the molten second mixture together in a feed-block to produce a laminated molten structure in the extrusion die. The first mixture of step (a) and second mixture of step (b) are laminated together in a feed-block to produce a laminated molten structure and are extruded through a die to shape, form, or extrude the BOPET material into the desired configurations.

The melts from the first and the second mixture are shaped to flat melt films in a multilayer die and are layered one above the other. Subsequently, the multilayer film is drawn off with the die of a chill roll, and, optionally, further rolls and solidified. The biaxial stretching of the film can be carried out separately, sequentially, or simultaneously. In some embodiments, the biaxial stretching of the film is carried out sequentially. In other embodiments, the biaxial stretching of the film is carried out simultaneously. In the sequential stretching, the stretching can be conducted first in longitudinal direction (i.e., in machine direction) and then in transverse direction (i.e., at cross direction or right angles to machine direction). Alternatively, the reverse sequence can be used. The stretching in longitudinal direction can be carried out with the dia of two rolls rotating at different rates in accordance with the desired stretch ratio. For transverse stretching, an appropriate tenter frame is used.

In some embodiments, the thermoplastic film may be first stretched in the longitudinal or machine direction, such that the thermoplastic film is preheated by a plurality of preheating rollers and then stretched in the longitudinal direction using a difference in peripheral speed between a pair of stretching rollers. In the stretching process, the film is heated and stretched longitudinally by a preheating roller or a stretching roller. Further, after the longitudinal stretching, it is cooled by a cooling roller and sent to the next step. The longitudinally stretched film can then be stretched in the transverse direction using a similar pre-heating and cooling rollers.

In some embodiments, the stretching is performed using a stretching slab and cooling by longitudinal stretching machine. In some embodiments, the longitudinal stretching preheat temperature is from about 65° C. to about 100° C., about 70° C. to about 90° C., or about 74° C. to about 85° C., and the chilling temperature is from about 20° C. to about 70° C., about 25° C. to about 65° C., or about 30° C. to about 62° C. Cross directional stretching may then be performed using a transverse drawing mill, thermal finalization, and cooling. In some embodiments, the cross directional stretch preheat temperature ranges from about 75° C. to about 125° C., about 80° C. to about 110° C., or about 98° C. to about 106° C., and the chilling temperature is from about 50° C. to about 100° C., about 60° C. to about 90° C., or about 65° C. to about 80° C.

Following preheat treatment and prior to chilling, the unstretched film is subjected to biaxial stretching by heat-treating the said film at a suitable temperature which may be from about 200° C. to about 350° C., about 275° C. to about 300° C., about 250° C. to about 290° C. or about 255° C. to about 280° C. In the processes of the present technology, the preservation of die temperature and stretch ratio are aspects which influencing film formation, crystallinity, and sealability. Accordingly, in one aspect, the stretching is carried out in the machine direction orientation (MDO) or longitudinal direction at a temperature be from about 150° C. to about 350° C., including from about 200° C. to about 325° C., about 225° C. to about 300° C., about 250° C. to about 290° C., or about 275° C. to about 280° C. The stretching is carried out in the cross-sectional or transverse direction orientation (TDO) at a temperature of about 50° C. to 300° C., including from about 80° C. to about 275° C., about 100° C. to about 250° C., about 150° C. to about 240° C., or about 215° C. to about 230° C. The TDO stretching may include a TDO stretching zone and/or a TDO crystallization zone. The TDO stretching zone temperature may be from about 50° C. to about 250° C., including from about 80° C. to about 225° C., about 100° C. to about 200° C., about 110° C. to about 190° C., or about 112° C. to about 185° C. The TDO crystallization zone temperature may be from about 50° C. to about 300° C., including from about 100° C. to about 280° C., about 175° C. to about 275° C., about 200° C. to about 250° C., or about 215° C. to about 230° C.

The stretching is carried out in the machine direction orientation (MDO) or longitudinal direction such that the stretch ratio in the longitudinal direction is from about 1 times to about 6 times based on the original length of the unstretched film, including from about 2 times to about 5 times, about 2.5 times to about 4 times, about 2.8 times to about 3.8 times, about 3 to about 3.6 times, or about 3 times to about 3.4 times. The stretching is carried out in the transverse direction orientation (TDO) or cross-sectional direction such that the stretch ratio is from about 1 times to about 8 times based on the original width of the unstretched film, including from about 1.5 times to about 7 times, about 2 times to about 6 times, about 2.5 times to about 4.8 times, about 3.2 to about 4.5 times, or about 3.5 times to about 4.2 times.

In some embodiments, the first machine direction or longitudinal stretch draw ratio may be from about 0.5% to about 4%, including from about 0.8% to about 3%, about 0.9% to about 2.5%, about 1% to about 2% or about 1.01% to about 1.8%. In some embodiments, the second machine direction or longitudinal stretch draw ratio may be from about 1% to about 6%, including from about 2% to about 5%, about 2.5% to about 4%, about 2.8% to about 3.8% or about 3% to about 3.4%. In some embodiments, the transverse direction or cross directional stretch draw ratio can be about 1% to about 8%, including from about 1.5% to about 7%, about 2% to about 6%, about 2.5% to about 4.5% or about 3.5% to about 4.2%.

Before or after the transverse stretching, one or both surfaces of the film can be coated using an inline or offline coating process. The inline coating may provide, for example, improved adhesion between a metal layer and/or a printing ink layer and the film, an improvement in the antistatic performance, in the processing performance or else further improvement of barrier properties of the film. The latter is achieved, for example, by applying polymeric coating materials like polyvinyl alcohol (PVOH), ethylene vinyl alcohol (EVOH), polyvinylidene dichloride (PVDC) or the like, by using an offline coating process. In that case, preference is given to applying such layers to the non-heat sealable surface, e.g., the surface of the outer most layer of the film, although in some cases the functional layers can be applied to the heat-sealable surface.

The heat-sealing temperature of biaxially-oriented ultra-heat sealable polyester film may be from about 40° C. to about 300° C., including from about 50° C. to about 250° C., about 100° C. to about 200° C., about 130° C. to about 180° C., or about 150° C. to about 160° C. The seal initiation temperature of the films may be from about 50° C. to about 200° C., including about 60° C., about 80° C., about 100° C., about 110° C., about 120° C., about 130° C., about 140° C., or about 150° C.

In one embodiment, a process for preparing a biaxially-oriented ultra-heat-sealable polyethylene terephthalate film is provided. The process includes preparing a core layer mixture comprising polyethylene terephthalate, modified polyethylene terephthalate, post-consumer recycled polyester and a filler, wherein the modified polyethylene terephthalate comprises fiber-grade polyester; preparing a heat-sealable layer mixture comprising a heat-sealable co-polyester; charging the core layer mixture to a main extruder to obtain a molten first mixture; charging the heat-sealable layer mixture to a sub-extruder to obtain a molten second mixture; extruding the molten first mixture and the molten second mixture through a die to provide an unstretched film; and biaxially stretching the unstretched film under preheating conditions and heat-treating said film to a temperature of from about 250° C. to about 290° C., such that the stretch ratio in the longitudinal direction is from about 3 to about 3.6 times based on the original length of the unstretched film, and the stretch ratio in the transverse direction is from about 3.2 to about 4.5 times based on the original width of the unstretched film; cooling the stretched film to obtain a biaxially-oriented ultra-heat-sealable polyethylene terephthalate film; wherein a heat-sealing temperature of the biaxially-oriented ultra-heat-sealable polyethylene terephthalate film is about 100° C. to about 200° C. In some embodiments, the biaxially-oriented ultra-heat-sealable polyester film of the present technology has at least two layers.

In some embodiments, the preparation of a heat-sealable layer mixture includes charging in a reactor terephthalic acid, dimethyl terephthalate or a combination thereof with at least one diol and isophthalic acid to obtain a reaction mixture; subjecting the reaction mixture to an esterification reaction at a temperature of about 240° C. to about 270° C. to obtain an esterified prepolymer; charging the esterified prepolymer to a polycondensation reactor and adding one or more polycondensation catalyst selected from silica, antimony compounds and magnesium compounds; subjecting the prepolymer to a polycondensation reaction at a temperature in the range of about 270° C. to about 310° C. to obtain a molten amorphous polymer; cooling and processing the molten polymer to form chips or pellets; and optionally subjecting the resultant chips to solid state polymerization, to obtain a heat-sealable layer mixture comprising a heat-sealable co-polyester having an intrinsic viscosity greater than 0.65 dL/g.

In some embodiments of the process of present technology, the heat-sealable co-polyester includes about 35 to about 70% by weight of terephthalic acid, dimethyl terephthalate, or a combination thereof; about 21 wt. % to about 40 wt. % of mono ethylene glycol, diethylene glycol, triethylene glycol, 1,3-propanediol, 1,4-butanediol, neopentyl glycol, hexamethylene glycol, cyclohexanedimethanol, or a mixture of any two or more thereof; and about 10 wt. % to about 30 wt. % isophthalic acid. In some embodiments of the process of present technology, the core layer mixture includes about 40 wt. % to about 80 wt. % polyethylene terephthalate polyester; about 0 wt. % to about 30 wt. % fiber-grade polyester; about 20 wt. % to about 100 wt. % post-consumer recycled polyethylene terephthalate; and about 0.05 wt. % to about 0.1 wt. % silica. In some embodiments of the process of present technology, the polyethylene terephthalate polyester of the core layer mixture includes about 70 wt. % to about 85 wt. % terephthalic acid, about 20 wt. % to about 30 wt. % mono ethylene glycol, and about 0.5 wt. % to about 5 wt. % diethylene glycol. In some embodiments of the process of present technology, the fiber-grade polyester of the core layer mixture includes about 65 wt. % to about 85 wt. % terephthalic acid, about 20 wt. % to about 30 wt. % mono ethylene glycol, and about 2 wt. % to 10 wt. % diethylene glycol.

In some embodiments of the process of present technology, the processing step includes subjecting the extruded structure to one or more steps of preheating, stretching, and cooling. In some embodiments, the stretching is conducted sequentially or simultaneously in the machine direction and the transverse direction. In some embodiments, the preheating, stretching and cooling includes machine direction preheating, stretching, and cooling followed by transverse direction preheating, stretching, and cooling. In some embodiments, the preheating conditions include passing the unstretched film through a machine direction preheating zone at a temperature of about 70° C. to about 90° C., stretching the preheated structure in a longitudinal direction, and passing the longitudinally stretched film through a machine direction cooling zone at a temperature of about 70° C. to about 90° C.

In some embodiments of the process of present technology, the process further includes passing the cooled longitudinally stretched film through a transverse direction preheating zone at a temperature of about 92° C. to about 110° C., stretching the preheated film in a transverse direction, and passing the transversely stretched film through a machine direction cooling zone at a temperature of about 60° C. to about 85° C.

In some embodiments, the process of present technology further includes adding an additional layer to the biaxially-oriented ultra-heat sealable polyester film. In some embodiments, the additional layer includes one or more of a sealant layer, a printing layer, a metal layer, a barrier layer, an adhesive layer, a coating layer, a primer layer, and a protective layer.

In some embodiments, the PET polymer and modified PET polymer in the core layer may be replaced up to and including 100% by recycled PET. However, it is preferable that the sealant layer components are not replaced by recycled PET. This is because of its high comonomer content, preventing it from crystallizing during stretching and at elevated temperatures, which provides seal strength to the film. The overall ratio of the core layer to the sealant layer may be about 50:50, including but not limited to about 60:40. Increasing the PET polymer, modified PET polymer, and recycled PET content will result in a lower seal strength because the comonomer content in the sealant layer is responsible for imparting ultra-sealability to the film. However, PET polymer, Modified PET polymer, and R pet content provide mechanical strength and stability at higher temperatures.

The biaxially-oriented ultra-heat sealable polyester films may be used by itself, or it can be used as a laminated film. The films may optionally include other layers, including but not limited to a sealant layer, a printing layer, a metal layer, a barrier layer, an adhesive layer, a coating layer, a primer layer, a protective layer, or a combination of any two or more thereof. The films can be used to produce high barrier films or laminate structures with functional coatings and metal deposition on film surface, including for example, sealable transparent films, metallized sealable films (e.g., surface metallized with better printability on metal surface, primed metal surface for ink and adhesive adhesion), laminate structures including the sealable films. In particular, the present technology provides biaxially-oriented PET films that are capable of providing ultra-high heat seal strength and laminate structures and includes processes for producing and using the sealable films and laminate structures.

The biaxially-oriented ultra-heat sealable polyester films may be used to make multilayer high-barrier films (laminates). The multilayer high-barrier films including the biaxially-oriented ultra-heat sealable polyester film of the present technology may include a barrier layer disposed on at least one of the one or more of the core layers. The barrier layer may include at least one of ethylene vinyl alcohol copolymers, polyvinyl alcohol polymers and copolymers, or polyvinylidene dichloride, aluminum, silicon oxide, and aluminum oxide. The barrier film may be unprinted or reverse-printed. The multilayer high-barrier film may have a water vapor transmission rate in the range of 0.30 to 0.40 g/m²-day, and oxygen transfer rate in the range of 0.40 to 0.50 cc/m²-day.

The films and polymer compositions described herein can be utilized for various applications. The films are useful in both vertical form fill seal (VFFS) and horizontal form fill seal (HFFS), with VFFS being the more preferred technology. The films possess excellent runability during pouch making. Typical end-use applications include, but are not limited to, packaging, insulating material, printing mediums, electronics, acoustics, and food contact applications etc. The films can be used as recyclable, flexible packaging solution like pouch and laminate making for food, medical and cosmetic items packaging. For example, the films can be used for packaging foods and other consumable goods, pharma products, powder packaging sachets, tea powder packaging, spices packaging pouches, outer packaging pouches, vacuum packaging, etc. The films are suitable to be used as a barrier film, a release film, or as packaging material. The films are particularly suitable for the packaging of foods, medical products and other consumable goods which require high resistance to bag breakage in trays in which peelable polyester films are used for opening the packaging. The films are also useful for manufacturing mono material multilayer laminates to obtain high package strength with improved barrier properties. In one aspect, provided are packaging materials which include the biaxially-oriented ultra-heat sealable polyester film of the present technology. In yet another aspect, provided are packaging materials which include the biaxially-oriented ultra-heat sealable polyester film produced by the process of the present technology. In some embodiments, the films include food grade packaging films or medical products packaging films.

The compositions, films and methods described herein offer significant advantages, including, but not limited to extensive reduction in the complexity of packaging products, reduction in the fluctuation of the quality and quantity of recycled products delivered to consumers, and a decrease in the amount of non-recyclable fractions owing to the ability to replace multilayer laminate to single layer or multilayer mono-material laminate. The use of modified PET polymer, and the PCR-grade pet content provide mechanical strength and stability at higher temperatures. The films are cost-effective, environmentally friendly, and reduce carbon footprint since they are produced with PCR-grade polyethylene terephthalate. Packages made from these films are also recyclable. Additionally, the films have excellent bag breakage resistance, better oxygen and moisture barrier properties, high mechanical strength (e.g., tensile strength, toughness and elongation), improved optical properties, balance shrinkage at elevated temperature in longitudinal and machine direction, high temperature dimensional stability, puncture resistance, high seal strength with low seal initiation temperature, produce mono material film or laminate package with high seal strength, and have the ability to replace cast PE films, blown PE, and/or CPP films to provide sustainable packaging solutions.

The present invention, thus generally described, will be understood more readily by reference to the following examples, which are provided by way of illustration and are not intended to be limiting of the present invention.

### EXAMPLES

In the examples below as well as throughout the application, the following abbreviations have the following meanings. If not defined, the terms have their generally accepted meanings.
PET: Polyethylene terephthalate,
DMT: dimethyl terephthalate,
IPA: Isophthalic acid,
NPG: 2,2-dimethylpropane-1,3-diol,
CHDM: Cyclohexanedimethanol,
BHET: Bis(hydroxyethyl)terephthalate
PTA: Purified terephthalic acid,
rPET: recycled PET,
PCR: Post-consumer recycled,
MEG/EG: Mono ethylene glycol/ethylene glycol,
DEG: Diethylene glycol,
BOPET: biaxially-oriented polyester
APET: amorphous polyethylene terephthalate,
CPET: crystalline polyethylene terephthalate,
SSP: Solid state polymerization,
dl/gm: deciliters per gram,
wt. %: weight percentage,
I.V.: intrinsic viscosity,
T_{g}: glass transition temperature,
T_{ch}: crystallization temperature,
Tₘ: melting temperature

### Intrinsic Viscosity

Intrinsic viscosity (I.V.) is a measure of the molecular mass of the polymer and is measured by dilute solution using an Ubbelohde viscometer. All intrinsic viscosities are measured in a 60:40 mixture of phenol and s-tetrachloroethane with 0.5% concentration. The flow time of solvent and solution are checked under I.V. water bath maintained 25° C. The I.V., η, was obtained from the measurement of relative viscosity, nr, for a single polymer concentration by using the Billmeyer equation:

$$IV = [ η ] = 0.25 [ ( RV - 1 ) + 3 ln RV ] / c$$

where: η is the intrinsic viscosity, RV is the relative viscosity; and c is the concentration of the polymeric solution (in g/dL). The relative viscosity (RV) is obtained from the ratio between the flow times of the solution (t) and the flow time of the pure solvent mixture (to).

$$R V = {n}_{rel} = Flow time of solution ( t ) / Flow time of solvent ( {t}_{0} )$$

I.V. must be controlled so that process ability and end properties of a polymer remain in the desired range. Class ‘A’ certified burette being used for IV measurement for more accuracy.

### DSC Analysis

The Differential Scanning calorimeter is a thermal analyzer which can accurately and quickly determine the thermal behavior of Polymers such as glass transition temperatures (Tg), crystallization exothermic peak temperatures (Tch), peak endotherm temperatures (Tm), heats of crystallization (ΔH) and heats of fusion for all materials. A Perkin-Elmer model Jade DSC was used to monitor thermal properties of all polymer samples at heating and cooling rates of 10° C. per minute. A nitrogen purge was utilized to prevent oxidation degradation.

### Crystallinity Analysis by DSC and DGC

The Differential Scanning calorimeter (DSC) and Density Gradient Column (DGC) are used to calculate the crystallinity of polymer samples.

By DSC, the crystallinity is calculated by heat of fusion ((ΔH) of Tml (Heat 1 cycle) with specific heat of polymer.

By DGC (Density Gradient Column), the crystallinity is calculated with the help of known standard balls floating at the Lloyds densitometer.

The following examples are given for the purpose of illustrating various embodiments of the invention and are not meant to limit the present invention in any fashion. The present examples, along with the methods described herein are presently representative of preferred embodiments, are exemplary, and are not intended as limitations on the scope of the invention. Changes therein and other uses which are encompassed within the spirit of the invention as defined by the scope of the claims will occur to those skilled in the art.

Example 1: Preparation of heat-sealable co-polyester 1. To a 0.2 m³ volume reactor equipped with a mechanical stirrer, a packed refluxing column, a nitrogen inlet, and a heat source were added 30 kg of ethylene glycol, 56.3 kg of PTA, and 12.8 kg IPA. Esterification was carried out at a temperature of 248 to 260° C. under pressure up to 3.0 bars for 2 to 3 hours. After completion of about 90% of the esterification, the reactor was depressurized and trimethyl phosphate added. The resulting BHET (bis(hydroxyethyl) terephthalate) was then transferred into a polycondensation reactor. 34.8 g antimony trioxide, 52 g MgAc₂ and 400 g of SiO₂ slurry (10% concentrated in MEG) were added and the reaction mixture was hold for 10 min for mixing. A polycondensation reaction was then carried out at temperature of 280° C. to 300° C. under a pressure of less than 0.2 torr. After sufficient melt viscosity (e.g., about 1036 poise at 280° C.) was achieved, the polymerization was stopped. The molten polymer was cooled in the cold water and then chopped to form pellets. The intrinsic viscosity of the amorphous polymer was 0.680 dl/g and throughput of product from reactor was more than 98.5% (yield).

Example 2: Preparation of heat-sealable co-polyester 2. To a 0.2 m³ volume reactor equipped with a mechanical stirrer, a packed refluxing column, a nitrogen inlet and a heat source were added 30 kg of ethylene glycol, 51.1 kg of PTA, and 18 kg IPA. Esterification was carried out at temperature of 248° C. to 260° C. under pressure up to 3.0 bars for 2 to 3 hours. After completion of about 90% esterification, the reactor was depressurized and trimethyl phosphate added. The BHET was transferred into polycondensation reactor. 34.8 g antimony trioxide, 52 g MgAc₂ and 400 g of SiO₂ slurry (10% concentrated in MEG) were added and the reaction mixture was hold for 10 min for mixing. Polycondensation reaction was carried out at temperature of 280° C. to 300° C. under pressure of less than 0.2 torr. After sufficient melt viscosity was achieved, polymerization was stopped. The molten polymer was cooled in the cold water and then chopped to form pellets. The intrinsic viscosity of the amorphous polymer was 0.680 dl/g and throughput of product from reactor was more than 98.5% (yield).

Example 3: Preparation of heat-sealable co-polyester 3. To a 0.2 m³ volume reactor equipped with a mechanical stirrer, a packed refluxing column, a nitrogen inlet and a heat source were added 30 kg of ethylene glycol, 44.7 kg of PTA, and 24.0 kg IPA. Esterification was carried out at temperature of 248-260° C. under pressure up to 3.0 bars for 2-3 h. After completion of 90% esterification, the reactor was depressurized and trimethyl phosphate added. The BHET was transferred into polycondensation reactor. 34.8 g antimony trioxide, 52 g MgAc₂ and 400 g of SiO₂ slurry (10% concentrated in MEG) were added and the reaction mixture was hold for 10 min for mixing. Polycondensation reaction was carried out at temperature of 280° C. to 300° C. under pressure of less than 0.2 torr. After sufficient melt viscosity was achieved, polymerization was stopped. The molten polymer was cooled in the cold water and then chopped to form pellets. The intrinsic viscosity of the amorphous polymer was 0.680 dl/g and throughput of product from reactor was more than 98.1% (yield).

Due to high co-monomer content, polymer could not be crystallized and it was not possible to dry up to minimum moisture level, which caused the intrinsic viscosity to drop significantly during process. Therefore, the intrinsic viscosity was in melt phase in three reactor process (Esterification, Pre-polymerization and Polymerization) and used up to 30% blending process.

Example 4: Preparation of heat-sealable co-polyester 4. To a 0.2 m³ volume reactor equipped with a mechanical stirrer, a packed refluxing column, a nitrogen inlet and a heat source were added 28 kg of ethylene glycol, 3.6 kg Neopentyl glycol, 48.2 kg of PTA, and 20 kg of IPA. Esterification was carried out at temperature of 248-260° C. under pressure up to 3.0 bars for 2-3 h. After completion of 90% esterification, the reactor was depressurized and trimethyl phosphate added. The BHET was transferred into polycondensation reactor. 34.8 g antimony trioxide, 52 g MgAc₂ and 400 g of SiO₂ slurry (10% concentrated in MEG) were added and the reaction mixture was hold for 10 min for mixing. Polycondensation reaction was carried out at temperature of 280° C. to 300° C. under pressure of less than 0.2 torr. After sufficient melt viscosity was achieved, polymerization was stopped. The molten polymer was cooled in the cold water and then chopped to form pellets. The intrinsic viscosity of the amorphous polymer was 0.680 dl/g and throughput of product from reactor was more than 98.5% (yield).

Due to high co-monomer content, polymer could not be crystallized and it was not possible to dry up to minimum moisture level, which caused the intrinsic viscosity to drop significantly during process. Therefore, the intrinsic viscosity was increased in melt phase in three reactor process (Esterification, Pre-polymerization and Polymerization).

Example 5: Preparation of heat-sealable co-polyester 5. To a 8.0 m³ volume reactor equipped with a mechanical stirrer, a packed refluxing column, a nitrogen inlet and a heat source were added 495.0 kg of ethylene glycol, 259.2 kg Neopentyl glycol, and 1490.6 kg of PTA. Esterification was carried out at temperature of 248-260° C. under pressure up to 3.0 bars for 2-3 h. After completion of 90% esterification, the reactor was depressurized and trimethyl phosphate added. The BHET was transferred into polycondensation reactor. 435 ppm antimony trioxide, 650 ppm MgAc₂ and 300 ppm of SiO₂ slurry (10% concentrated in MEG) were added and the reaction mixture was hold for 10 min for mixing. The polycondensation reaction was carried out at temperature of 280° C. to 300° C. under pressure of less than 0.2 torr. After sufficient melt viscosity was achieved, polymerization was stopped. The molten polymer was cooled in the cold water and then chopped to form pellets. The intrinsic viscosity of the amorphous polymer was 0.745 dl/g and throughput of product from reactor was more than 98.5% (yield).

For some co-polyesters, owing to a high co-monomer content, the polymer was not able to crystallize in a tumble dryer. In such cases, a three-stage crystallization was performed. Materials depicted in Table 1, Example 5 NHI were passed through rotatory crystallizers with 60% through and 80° C. to 90° C. temperature and materials transfer through fluidized bed crystallizer up to 100° C. to 110° C. product temperature and finally materials charge in tumble dryer and heat up to 70° C. to 160° C. product temperature for 8 to 12 hrs. The final polymer has 23% crystallinity and 100 ppm moisture and materials can be dry easily before processing.

Example 6: Preparation of heat-sealable co-polyester 6. Blends from Example 3 and Example 5 with ratio of 70:30 were used to prepare the co-polyester. The intrinsic viscosity of the amorphous polymer was 0.745 dl/g and sealing strength of film was 1450 μm/inch.

Table 1 outlines the raw materials used for synthesizing the co-polyesters of Examples 1 through 6.

TABLE 1
Formulations for making low melt co-polyesters.

| Example No. | | 1 | 2 | 3 | 4 | 5 | 6 |
|---|---|---|---|---|---|---|---|
| PTA (kgs) | | 56.3 | 51.1 | 44.7 | 48.2 | 1490.6 | Ex. 3: 70% |
| IPA (kgs) | | 12.8 | 18.0 | 24.0 | 20.0 | 0.0 | Ex. 5: 30% |
| MEG (kgs) | | 30.0 | 30.0 | 30.0 | 30.0 | 495.0 | — |
| Neopentyl | kgs | — | — | — | 3.6 | 259.2 | — |
| glycol | wt. % | nil | Nil | nil | 3.0% | 8.9% | 2.7% |

| | | | | | | |
|---|---|---|---|---|---|---|
| PTA (wt. %) | 59.3% | 53.8% | 47.3% | 50.8% | 70.1% | 54.1% |
| IPA (wt. %) | 13.5% | 19.0% | 25.4% | 21.1% | 0.0% | 17.8% |
| MEG (wt. %) | 27.2% | 27.2% | 27.3% | 25.1% | 21.0% | 25.4% |
| Sb₂O₃ (ppm) | 435 | 435 | 435 | 435 | 435 | — |
| TMP (ppm) | 375 | 375 | 375 | 375 | 375 | — |
| MgAC₂ (ppm) | 650 | 650 | 650 | 650 | 650 | — |
| SiO₂ (ppm) | 500 | 500 | 500 | 500 | 300 | — |

The DSC parameters used for measuring various characteristics including intrinsic viscosity (I. V.), sealing strength, melting, and glass transition temperatures of the polymers are provided in Table 2 and the results of the DSC analysis are summarized in Table 3 below.

TABLE 2
DSC parameters for analysis

| Example No. | 1 | | 2 | | 3 | | 4 | | 5 | | 6 |
|---|---|---|---|---|---|---|---|---|---|---|---|
| Final Cut Off | 5.7 | amp. | 5.2 | amp. | 5.5 | amp. | 5.7 | amp. | 42.5 | amp | — |
| EI Cycle Time (min) | 270 | min | 245 | min | 250 | min | 235 | min | 296 | min | — |
| EI Peak Temp (° C.) | 261.5 | | 258.7 | | 258.0 | | 258.1 | | 260.0 | | — |
| PC Cycle Time (min) | 153 | min | 148 | min | 168 | min | 149 | min | 229 | min | — |

| | | | | | | |
|---|---|---|---|---|---|---|
| PC Peak Temp (° C.) | 284.1 | 286.3 | 284.5 | 284.4 | 288.3 | — |

TABLE 3
Analysis of prepared co- polyesters

| Example No. | 1 | 2 | 3 | 4 | 5 | 6 |
|---|---|---|---|---|---|---|
| I.V. (Dl/g) | 0.680 | 0.680 | 0.683 | 0.698 | 0.745 | 0.710 |
| —COOH (meq/Kg) | 30 | 27 | 24 | 24 | 24 | 24 |
| Chips/gm (Nos) | 40 | 58 | 62 | 52 | 57 | 61 |
| Color L* | 49.4 | 54.8 | 49.0 | 56.0 | 53.6 | 51.3 |
| Color a* | −1.4 | −1.4 | −1.4 | −1.2 | −3.1 | −1.8 |
| Color b* | 6.6 | 6.2 | 6.0 | 3.2 | 12.4 | 9.1 |
| DEG (wt. %) | 3.92 | 2.55 | 3.35 | 2.13 | 1.48 | 3.15 |
| IPA (wt. %) | 15.90 | 21.10 | 30.20 | 25.10 | — | 22.91 |
| NPG (wt. %) | — | — | — | 3.73 | 10.30 | 2.51 |
| Tg1 (C) | 75.9 | 73.2 | 71.7 | 70.9 | 78.9 | 66.6 |
| Tch1 (° C.) | not | not | not | not | not | not |
| | detected | detected | detected | detected | detected | detected |
| Tm1 (° C.) | 205.6 | not | not | not | 179.5 | 178.5 |
| | | detected | detected | detected | | |
| Delta H1 (° C.) | 28.6 | — | — | — | 26.5 | 23.5 |
| Tg2 (° C.) | 76.6 | 74.2 | 71.4 | 72.0 | 79.5 | 71.0 |
| Tch2 (° C.) | not | not | not | not | not | not |
| | detected | detected | detected | detected | detected | detected |
| Tm2 (° C.) | not | not | not | not | not | not |
| | detected | detected | detected | detected | detected | detected |
| Delta H2 (J/g) | — | — | — | — | — | — |
| Crystallinity after | 24.9 | — | — | — | 23.0 | 20.4 |
| crystallization (%) | | | | | | |
| Capillary melting | 192 | 168 | 130 | 140 | 179.5 | 176.5 |
| point (° C.) | | | | | | |
| Total Yield (wt. %) | 98.5 | 98.5 | 98.1 | 98.5 | 98.9 | — |

### Example 7: Solid State Polymerization

BRT polymer: The molecular weight of the polymer of Examples 1-6 could be significantly increased by first loading the polymer pellets on a tumble dryer and heating the contents under a stream of nitrogen up to 110° C. over a period of 11 h to get the crystallized polymer. After crystallization, high vacuum was applied to the dryer and the crystallized pellets are heated up to 230° C. for 10 to 15 h. This effected a solid-state polymerization and allowed the molecular weight to be significantly increased. In general, film manufacturing processes use PET IV of 0.620 dl/gm. However, in this process a high IV of 0.750 dl/gm PET was targeted for smooth running and higher sealing strength.

### Example 8: Preparation of FGT PET Chips

To a 8.0 m³ volume reactor equipped with a mechanical stirrer, a packed refluxing column, a nitrogen inlet and a heat source were added 616.23 kg of ethylene glycol, 105 kg diethylene glycol, and 1601.18 kg of PTA. Esterification was carried out at temperature of 248-260° C. under pressure up to 3.0 bars for 2-3 h. After completion of 90% esterification, the reactor was depressurized and trimethyl phosphate added. The BHET was transferred into polycondensation reactor. 435 ppm antimony trioxide, 150 ppm MgAc₂ were added and the reaction mixture was hold for 10 min for mixing. The polycondensation reaction was carried out at temperature of 280° C. to 300° C. under pressure of less than 0.2 torr. After sufficient melt viscosity was achieved, polymerization was stopped. The molten polymer was cooled in the cold water and then chopped to form pellets. The intrinsic viscosity of the amorphous polymer was 0.650 dl/g and throughput of product from reactor was more than 99.1% (yield).

Crystallization of the polymer is performed using the crystallizer to induce controlled crystallinity in molten PET during the manufacturing process (Crystallinity-40-50%). This controlled crystallization promotes the formation of a structured crystalline matrix within the polymer. The result is an enhancement of the film's mechanical strength, dimensional stability, and barrier properties (Temp-160-170° C.). Following the crystallization process, the PET chips are dried in the dryer to eliminate residual moisture.

The dryer utilizes hot air to efficiently evaporate the water content, ensuring that the finish product attains the desired moisture level. Drying temp ranges from 165-170° C., and the moisture is reduced down to 40-60 ppm from 2000 ppm. This step is essential for achieving uniform film quality, physical properties, and optical clarity.

The dried PET chips are introduced into a vacuumed hopper, which facilitates controlled feeding and metering of PET resin into the extruder. Applying vacuum to the hopper ensures a consistent and uniform flow of the polymer material, thereby providing consistent film thickness and properties.

### Example 9: Manufacturing Process for Biaxially-Oriented Ultra-Heat Sealable Polyester Film

### A. General Process for Extrusion of Biaxially-Oriented Films

(a) Thermoplastic polyethylene terephthalate (PET), modified PET pellets, and postconsumer recycled polyester chips in combination with silica (filler) having desired properties, are fed into the main extrusion line at a temperature in the range of 255-280° C. to obtain a first mixture; and
(b) co-polyester of examples 1-6 presented in Table 1 are fed into the sub-extrusion process at a temperature of 260-280° C. to obtain a second mixture.

The steps (a) and (b) of the extrusion process allow the materials to melt separately, following which the molten first mixture polymer passes through a filter. The first mixture of step (a) and second mixture of step (b) are then laminated together in a feed-block to produce a laminated molten structure and are extruded through a die to shape, form, or extrude the BOPET material into the desired configurations.

### B. Preparation of Biaxially-Oriented Films

Biaxially-oriented ultra-heat sealable polyester films of two-layer structure having different thickness (such as 15μ, 30μ or 50μ) were prepared using different core compositions along with co-polyesters of Examples 1-6. The biaxially-oriented ultra-heat sealable polyester films were prepared via a conventional sequential biaxial orientation machine having a mainline extrusion and sub-extrusion process. Stretching is undertaken using a stretching slab and cooling by longitudinal stretching machine, wherein the longitudinal stretch ratio is 3.0 to 3.4 times, longitudinal stretching preheat temperature is 74° C. to 85° C., and chilling temperature is 30° C. to 62° C. Cross directional stretching is then undertaken using a transverse drawing mill, thermal finalization, and cooling. Cross directional stretch ratio is 3.5 to 4.2 times, cross directional stretch preheat temperature is 98° C. to 106° C., and chilling temperature is 65° C. to 80° C.

### Preparation of Film A

TABLE 4
Outer layer of film A

| | Structure | Raw | Composition |
|---|---|---|---|
| | Layer | Material | (wt. %) |
| Structural | Outer Layer | 750 ppm | 750 ppm silica + 78% PET |
| Composition of | (Structural Layer) | Silica + | (73.5% PTA + 25% EG + |
| the film | or Core layer | PET + rPET | 1.5% DEG) + rPET 22% |

Film A is a biaxially-oriented ultra-heat sealable PET film having a two-layer structure i.e., inner layer (heat-sealable/sealant layer)/outer layer (Core layer). The compositions of Examples 1-6 were used as the inner layer. The outer layer was prepared from Polyethylene Terephthalate (PET), Post-Consumer Recycled (PCR) grade polyethylene terephthalate chips, and silica as a filler using the composition shown in Table 4. The outer layer and/or structural layer of the film comprises: 78% PET, which consists of 73.5 purified terephthalic acid (PTA)+25% of ethylene glycol (EG)+1.5% of diethylene glycol (DEG), 22% PCR grade chips (EFSA approved Starlinger iV+ technology) and 0.075% (750 ppm) silica as a filler. Various biaxially-oriented ultra-high heat-sealable polyester films of 20μ thickness having a two-layer structure (Films A1-A6) were produced using a range of processing parameters outlined in Table 5 below.

TABLE 5
Film manufacturing process parameters
Main Extrusion Temperature: 255-280° C.
Co-extrusion Temperature: 260-280° C.
MDO Stretching Temperature: 84-90° C.
MDO Draw Ratio: 2.7-3.4%
TDO Stretching Temperature: 112-185° C.

| Main Feeding (Core Layer) | | | | | |
|---|---|---|---|---|---|
| 750 ppm Silica + PET: 78% + rPET: 22% (for all films) | | | | | |
| Co-ex Feeding (Heat-sealable Co- polyester) | | | | | |
| Example 1 | Example 2 | Example 3 | Example 4 | Example 5 | Example 6 |
| Film | | | | | |
| A1 | A2 | A3 | A4 | A5 | A6 |

Processing Parameters

| | | | | | | |
|---|---|---|---|---|---|---|
| Thickness (μ) | 20 | 20 | 20 | 20 | 20 | 20 |
| Main Throughput (Kg/hr) | 800-2000 | 800-2000 | 800-2000 | 800-2000 | 800-2000 | 800-2000 |
| Co-ex Throughput (Kg/Hr) | 580-1000 | 580-1000 | 580-1000 | 580-1000 | 580-1000 | 580-1000 |
| Total Throughput (Kg/hr) | 1380-3000 | 1380-3000 | 1380-3000 | 1380-3000 | 1380-3000 | 1380-3000 |
| Die Temp (° C.) | 275-280 | 275-280 | 275-280 | 275-280 | 275-280 | 275-280 |
| Chill roll Speed (m/min) | 30-62 | 30-62 | 30-62 | 30-62 | 30-62 | 30-62 |
| MDR-1st Draw Ratio (%) | 1.01 | 1.01 | 1.01 | 1.01 | 1.01 | 1.01 |
| MDR-2nd Draw Ratio (%) | 3.0-3.4 | 3.0-3.4 | 3.0-3.4 | 3.0-3.4 | 3.0-3.4 | 3.0-3.4 |
| MDO Preheating zone Temperature (° C.) | 74-85 | 74-85 | 74-85 | 74-85 | 74-85 | 74-85 |
| MDO Stretching zone Temperature (° C.) | 84-88 | 84-88 | 84-88 | 84-88 | 84-88 | 84-88 |
| MDO Cooling zone Temperature (° C.) | 25-35 | 25-35 | 25-35 | 25-35 | 25-35 | 25-35 |
| TDO Preheating zone Temperature (° C.) | 98-106 | 98-106 | 98-106 | 98-106 | 98-106 | 98-106 |
| TDO Crystallizing zone Temperature (° C.) | 215-230 | 215-230 | 215-230 | 215-230 | 215-230 | 215-230 |
| TDO Cooling zone Temperature (° C.) | 65-80 | 65-80 | 65-80 | 65-80 | 65-80 | 65-80 |
| TDO Draw ratio (%) | 3.5-4.2 | 3.5-4.2 | 3.5-4.2 | 3.5-4.2 | 3.5-4.2 | 3.5-4.2 |
| Relaxation % | 0.9-1.0 | 0.9-1.0 | 0.9-1.0 | 0.9-1.0 | 0.9-1.0 | 0.9-1.0 |

Various other films were similarly prepared using the process and parameters disclosed in Table 5. The compositions of Examples 1-6 were used as the inner layer, while the outer layer composition was varied as outlined in Examples B-D below. The compositions used for preparing the biaxially-oriented ultra-heat sealable polyester films of examples B, C and D are disclosed below.

### Preparation of Film B

TABLE 6
Outer layer of film B

| | Structure Layer | Raw Material | Composition (wt. %) |
|---|---|---|---|
| Structural | Outer Layer | 750 ppm | 750 ppm silica + 58% PET (73.5% |
| Composition | | Silica + PET + | PTA + 25% EG + 1.5% DEG) + |
| of the film | | FGT PET + rPET | 20% FGT PET (71% PTA + 23% |
| | | | EG + 6.0% DEG) + rPET 22% |

Film B is a biaxially-oriented ultra-heat sealable PET film, wherein the core layer includes thermoplastic polyethylene terephthalate, modified polyethylene terephthalate, PCR grade polyethylene terephthalate chips and silica as a filler. The outer layer and/or structural layer of the film comprises: 58% PET, which consists of 73.5 purified terephthalic acid (PTA)+25% of ethylene glycol (EG)+1.5% of diethylene glycol (DEG), 20% modified polyethylene terephthalate, 22% PCR grade chips and 0.075% (750 ppm) silica as a filler. The compositions of Examples 1-6 were used as the inner layer.

### Preparation of Film C

TABLE 7
Outer layer of film C

| | Structure | Raw | Composition |
|---|---|---|---|
| | Layer | Material | (wt. %) |
| Structural | Outer | 750 ppm | 750 ppm silica + 55% PET |
| Composition | Layer | Silica + PET + | (73.5% PTA + 25% EG + |
| of the film | | rPET | 1.5% DEG) + rPET 45% |

Film C is a biaxially-oriented ultra-heat sealable PET film, wherein the core layer includes thermoplastic polyethylene terephthalate, PCR grade polyethylene terephthalate chips, co-polyester chips, and silica as a filler. The outer layer and/or structural layer of the film comprises 55% PET, which consists of 73.5 purified terephthalic acid (PTA)+25% of ethylene glycol (EG)+1.5% of diethylene glycol (DEG), along with 45% PCR grade chips and 0.075% (750 ppm) silica as a filler. The compositions of Examples 1-6 were used as the inner layer.

### Preparation of Film D

TABLE 8
Outer layer of film D

| | Structure | Raw | Composition |
|---|---|---|---|
| | Layer | Material | (wt. %) |
| Structural | Outer | 750 ppm | 750 ppm silica + |
| Composition | Layer | Silica + rPET | rPET 100% |
| of the film | | | |

Film D is a biaxially-oriented ultra-heat sealable PET film, wherein the core layer includes post-consumer recycled (PCR) grade polyethylene terephthalate chips, and silica as a filler. The outer layer and/or structural layer of the film comprises: 100% PCR grade chips and 0.075% (750 ppm) silica as a filler. The compositions of Examples 1-6 were used as the inner layer.

### C. Analysis of Bi-axially Oriented Films

The prepared films were analyzed for their tensile strength, elongation, sealability, shrinkage and barrier properties. The results of analysis for film A compositions

TABLE 9
Properties of 20μ film A

| Main Feeding (Core Layer) | | | | | |
|---|---|---|---|---|---|
| 750 ppm Silica + PET: 78% + rPET: 22% | | | | | |
| Co-ex Feeding (Heat-sealable Co- polyester) | | | | | |
| Example 1 | Example 2 | Example 3 | Example 4 | Example 5 | Example 6 |
| Film | | | | | |
| A1 | A2 | A4 | A3 | A5 | A6 |

Tensile strength (ASTM D-882)

| | | | | | | |
|---|---|---|---|---|---|---|
| MD | 1800 | 1800 | 1800 | 1800 | 1800 | 1800 |
| TD | 1900 | 1900 | 1900 | 1900 | 1900 | 1900 |

Elongation (ASTM D-882)

| | | | | | | |
|---|---|---|---|---|---|---|
| MD | 130 | 130 | 130 | 130 | 130 | 130 |
| TD | 110 | 110 | 110 | 110 | 110 | 110 |
| Puncture Resistance (ASTM | 5.5-6.5 | 5.5-6.5 | 5.5-6.5 | 5.5-6.5 | 5.5-6.5 | 5.5-6.5 |
| F1306) | | | | | | |
| Seal initiation temperature ° C. | 100 | 100 | 100 | 100 | 100 | 100 |
| Seal Strength gmf/inch at 140° C., | 800 | 1150 | 1450 | 1800 | 600 | 2000 |
| 1 second @ 4 kg/cm² pressure | | | | | | |

Shrinkage @ 150° C. and 30 minutes (ASTM D-1204)

| | | | | | | |
|---|---|---|---|---|---|---|
| MD | 2.0 | 2.0 | 2.0 | 2.0 | 2.0 | 2.0 |
| TD | 1.8 | 1.8 | 1.8 | 1.8 | 1.8 | 1.8 |

Barrier properties

| | | | | | | |
|---|---|---|---|---|---|---|
| WVTR (ASTMF 1249) | 30-45 | 30-45 | 30-45 | 30-45 | 30-45 | 30-45 |
| OTR (ASTMD3985) | 80-100 | 80-100 | 80-100 | 80-100 | 80-100 | 80-100 |

The films prepared using copolymer compositions of Example 4 and Example 6 demonstrate enhanced sealability. The copolymer composition showcased in Examples 4 and 6 provides superior sealability compared to copolymer Examples 1, 2, 3, and 5. Similar analysis can be performed for film compositions of Examples B, C, and D.

### Example 10: Comparative Examples

A biaxial oriented ultra-high heat-sealable polyester film having two-layer structure and a comparative two-layered biaxial oriented standard (TF balance shrinkage) polyester film, both having of different thickness (such as 15μ, 30μ or 50μ) and were produced using the processing parameters outlined in Table 10 below.

Table-9, shows that Film of Example A was made with six different copolyester compositions, resulting in A1, A2, A3, A4, A5, and A6. Among all the Film A examples, A4 and A6 exhibited better seal strength, with A6 being the best among A1 to A6.

Table-10 serves as an example to clarify the differences between Heat Sealable films (15, 30, 50 Micron) and Non-Sealable Films (5, 30, 50 Micron Standard Films). Example E with 15 microns, Example F with 30 microns, and Example G with 50 microns of sealable film are compared with standard films of 15, 30, and 50 microns, which are non-sealable, in terms of processing parameters and seal strength.

TABLE 10
Comparison between Ultra-Heat Sealable film and Non-Sealable Film (Standard Film)

| | | | | Process parameters for Non Heat Sealable (standard Film) | | |
|---|---|---|---|---|---|---|
| Process parameters for Ultra-Heat Sealable Film | | | | Main Extrusion Temp- 255-280° C. | | |
| Main Extrusion Temp-255-280° C. | | | | Co-extrusion Temp -: 265-280° C. | | |
| Co-extrusion Temp -: 260-280° C. | | | | MDO Stretching temperature: 84-88° C. | | |
| MDO Stretching temperature: 84-90° C. | | | | MDO Draw Ratio: 2.8-3.4 % | | |
| MDO Draw Ratio: 2.7-3.4% | | | | TDO Stretching Temperature: 112-180° C. | | |
| TDO Stretching Temperature: 112-185° C. | | | | TDO Draw Ratio: 3.8-4.2% | | |
| TDO Draw Ratio: 3.5-4.2% | | | | Comparative | Comparative | Comparative |
| Examples | Example E | Example F | Example G | Example 1 | Example 2 | Example 3 |
| Main Feeding | 750 ppm | 750 ppm | 750 ppm | 300 (250-750 ppm) | 300 (250-750 ppm) | 300 (250-750 ppm) |
| | Silica + | Silica + | Silica + | ppm Silica + PET: | ppm Silica + PET: | ppm Silica + PET: |
| | PET: 78% + | PET: 78% + | PET: 78% + | 69.97% (PTA 73.5% + | 69.97% (PTA 73.5% + | 69.97% (PTA 73.5% + |
| | rPET: 22% | rPET: 22% | rPET: 22% | EG 25% + DEG | EG 25% + DEG | EG 25% + DEG |
| | | | | 1.5%) + rPET: 30% | 1.5%) + rPET: 30% | 1.5%) + rPET: 30% |
| Co-ex Feeding | Any example | Any example | Any example | 220 (200-1500 | 220 (200-1500 | 220 (200-1500 |
| | 1-6 of heat | 1-6 of heat | 1-6 of heat | ppm) ppm Silica | ppm) ppm Silica | ppm) ppm Silica |
| | sealable co- | sealable co- | sealable co- | PET Polymer 99.978: | PET Polymer 99.978: | PET Polymer 99.978: |
| | polyester: | polyester: | polyester: | (PTA 73.5% + EG | (PTA 73.5% + EG | (PTA 73.5% + EG |
| | 100% | 100% | 100% | 25% + DEG 1.5%) | 25% + DEG 1.5%) | 25% + DEG 1.5%) |
| Processing Parameters | | | | | | |
| Thickness (μ) | 15 | 30 | 50 | 15 | 30 | 50 |
| Main Throughput (Kg/hr) | 800-2000 | 800-2000 | 800-2000 | 2500-2600 | 2500-2600 | 2500-2600 |
| Co-ex Throughput (Kg/Hr) | 580-1000 | 580-1000 | 580-1000 | 350-400 | 350-400 | 350-400 |
| Total Throughput (Kg/hr) | 1380-3000 | 1380-3000 | 1380-3000 | 2850-3000 | 2750-3000 | 2750-3000 |
| Main Extrusion Temp (° C.) | 255-280° C. | 255-280° C. | 255-280° C. | 255-280° C. | 255-280° C. | 255-280° C. |
| Co-Extrusion Temp (° C.) | 260-280° C. | 260-280° C. | 260-280° C. | 265-280° C. | 265-280° C. | 265-280° C. |
| Die Temp (° C.) | 275-280° C. | 275-280° C. | 275-280° C. | 278-280° C. | 278-280° C. | 278-280° C. |
| Chill roll Speed (m/min) | 30-62 | 25-55 | 15-33 | 85-90 | 50-55 | 30-34 |
| MDR-1st Draw Ratio (%) | 1.01 | 1.01 | 1.01 | 1.01 | 1.01 | 1.01 |
| MDR-2nd Draw Ratio (%) | 3.0-3.4 | 2.7-3.2 | 2.7-3.0 | 3.2-3.4 | 3.0-3.1 | 2.8-3.0 |
| MDO Preheating zone | 74-85° C. | 74-85° C. | 74-85° C. | 74-83° C. | 74-83° C. | 74-84° C. |
| Temperature (° C.) | | | | | | |
| MDO Stretching zone | 84-88° C. | 84-88° C. | 84-90° C. | 84-86° C. | 85-88° C. | 86-88° C. |
| Temperature (° C.) | | | | | | |
| MDO Cooling zone | 25-35° C. | 25-35° C. | 25-35° C. | 28-30° C. | 28-30° C. | 28-32° C. |
| Temperature (° C.) | | | | | | |
| TDO Preheating zone | 98-106° C. | 98-106° C. | 98-106° C. | 100-104° C. | 100-104° C. | 100-104° C. |
| Temperature (° C.) | | | | | | |
| TDO Stretching zone | 112-185° C. | 112-185° C. | 112-180° C. | 112-180° C. | 112-180° C. | 112-170° C. |
| Temperature (° C.) | | | | | | |
| TDO Crystallizing zone | 215-230° C. | 215-230° C. | 215-225° C. | 232-235° C. | 232-235° C. | 225-230° C. |
| Temperature (° C.) | | | | | | |
| TDO Cooling zone | 65-80° C. | 65-80° C. | 65-80° C. | 60-80° C. | 60-80° C. | 60-80° C. |
| Temperature (° C.) | | | | | | |
| TDO Draw ratio (%) | 3.5-4.2% | 3.5-4.2% | 3.8-4.0% | 4.0-4.2 | 4.0-4.2 | 3.8-4.0 |
| Relaxation % | 0.9-1.0% | 0.9-1.0% | 0.9-1.0% | 0.9-1.0% | 0.9-1.0% | 0.9-1.0% |
| Seal Strength gmf/inch | 1500 | 3000 | 4500 | NA | NA | NA |
| (140° C./1 sec/4 kg/cm²) | | | | | | |

### Example 11: Process for Preparing Laminated Compositions

The first mixture from step (a) and the second mixture from step (b), as described in Example 9, were laminated together in a feed-block using the main extrusion and co-extrusion temperatures described in Table 5 and 10 to produce a laminated molten structure in an extrusion die. This process resulted in a two-layer structure comprising a core layer and a co-polyester layer.

### Example 12: Process for Preparing Packaging Compositions

### (I) Application of Ultra-Heat Sealable Film as Single Layer Packaging

a. Surface Printed Film

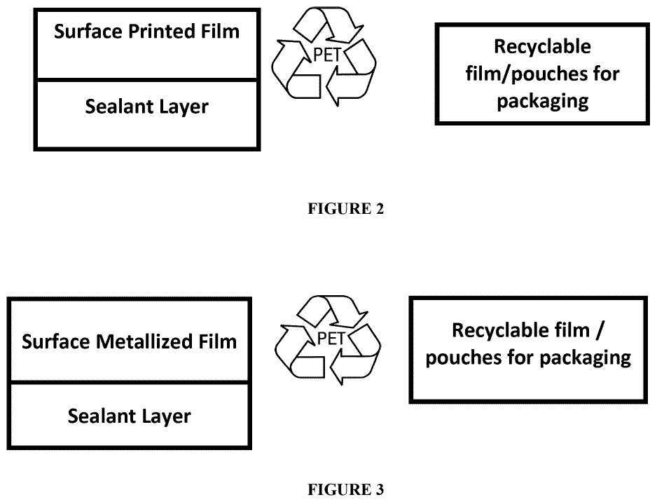

As illustrated in FIG. 2, the films described in the above Examples can be modified to include a surface printed layer on top of the sealant layer described in Examples 1-6 using conventional printing methods to improve aesthetic appeal and brand reputation. These environmentally friendly, recyclable films are designed for creating pouches or overwrap packaging to ensure product protection. These films enable the production of single-layer packaging pouches that use less plastic, thereby reducing plastic waste while still offering convenient sealing options. The benefit of such packaging is that due to the film's intrinsic property of sealing, there is no requirement for a sealant layer laminate. For the surface printed film, the Water Vapor Transmission Rate (WVTR) is less than 40 gm/m²/day, and the Oxygen Transmission Rate (OTR) is less than 100 cc/m²/day.

b. Surface Metalized Film for High Barrier Application

As illustrated in FIG. 3, the films described in the above Examples can be modified to include a surface metalized layer on top of the sealant layer described in Examples 1-6. Film metallization refers to the process of depositing a thin layer of metal onto the outer surface of the films of the present technology. These recyclable films are specifically designed for creating pouches or overwrap packaging with a high barrier to oxygen and moisture, ensuring optimal product protection. In instances where the metal comes into direct contact with environment, a metal protection coating is required to prevent any potential reaction or oxidation of metal. The metal layer is typically applied using standard methods such as vacuum metallization or sputtering. This process results in an ultra-high barrier film or laminate, having a Water Vapor Transmission Rate (WVTR) of less than 0.30 μm/m²/day, and the Oxygen Transmission Rate (OTR) of less than 0.40 cc/m²/day.

### (II) Application of Ultra-High Sealable Film in Multilayer Mono-Material Laminate for Packaging

Multilayer mono-material sustainable laminate offers a sustainable packaging solution that combines the benefits of recyclability, barrier properties, strength, and versatility, and are commonly used for Modified Atmosphere Packaging (MAP).

c. Transparent Film Laminate

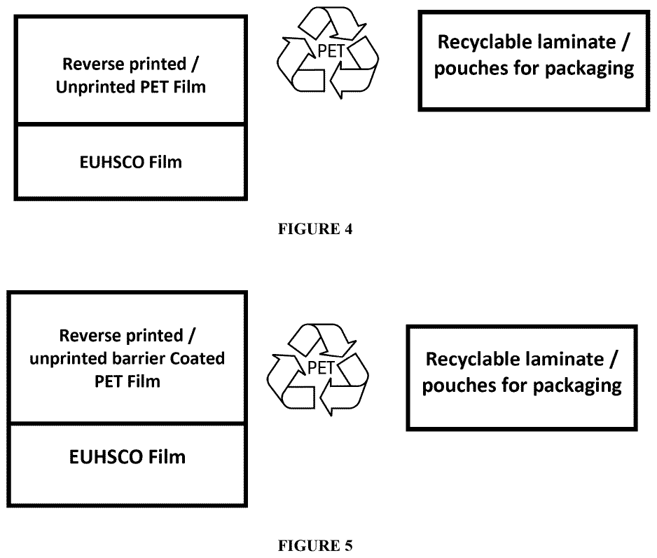

As illustrated in FIG. 4, the films described in the above Examples can be modified to include a reverse-printed or unprinted film. Transparent mono-material multilayer sustainable laminates are innovative packaging materials that offer transparency, sustainability, and multiple layers for enhanced performance. These laminates are designed to provide a clear and see-through packaging solution while minimizing the environmental impact. Transparent film laminates are manufactured using two distinct polyester films. One is an EUHSCO film (Ester Ultra Heat Seal Wound Inside, corona Treated Outside film) of the present technology, and the other is a non-sealable plain, corona-treated, chemical-primed, and/or reverse-printed film. The non-sealable film is laminated with EUHSCO using the extrusion lamination, solvent-based lamination process, or solventless lamination process. This type of laminate is produced by using one reverse-printed or unprinted film, which is then laminated with a sealable film using a compatible adhesive. The transparent film laminate has a Water Vapor Transmission Rate (WVTR) of less than 40 μm/m²/day, and the Oxygen Transmission Rate (OTR) of less than 100 cc/m²/day.

d. High Barrier Laminate

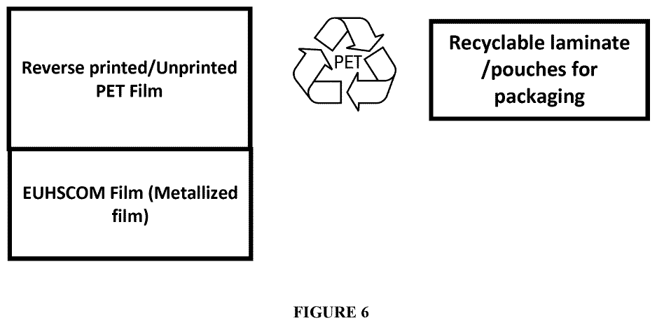

As illustrated in FIG. 5, the films described in the above Examples can be modified to include a high barrier layer. High barrier laminates are produced by using a barrier-coated film (coating material such as PVDC, EVOH, or PVOH) that is reverse-printed or left unprinted. This film is then laminated with a sealable film using a compatible adhesive. The high barrier laminate is manufactured using extrusion lamination, solvent-based lamination process, or solventless lamination process. High barrier laminates are specifically designed to offer a clear and see-through packaging solution while providing exceptional resistance to oxygen, moisture, and aroma. Water Vapor Transmission Rate (WVTR) for the high-barrier film is less than 8 μm/m²/day, and the Oxygen Transmission Rate (OTR) is less than 8 cc/m²/day.

e. Ultra-High Barrier Laminate

As illustrated in FIG. 6, the films described in the above Examples can be modified to include a ultra-high barrier layer. Ultra-high barrier multilayer mono-material laminates offer a combination of advanced barrier properties, visual aesthetics, and sustainability. These laminates are also used as a replacement for aluminum foil-based laminates, which are traditionally used to provide a barrier in Modified Atmosphere Packaging (MAP). Ultra-high barrier laminate is manufactured using two distinct polyester films. One is an metallized on non-sealable side EUHSCOM film, and the other is a non-sealable corona or chemical primed and or reverse-printed film. They are laminated with EUHSCO using the extrusion lamination, solvent-based lamination process, or solventless lamination process. Water Vapor Transmission Rate (WVTR) for the ultra-high barrier film is less than 0.20 μm/m²/day, and the Oxygen Transmission Rate (OTR) is less than 0.20 cc/m²/day.

The present invention, thus generally described, will be understood more readily by reference to the following examples, which are provided by way of illustration and are not intended to be limiting of the present invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges or a combination of any two or more of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A biaxially-oriented ultra-heat sealable polyester film comprising:
a core layer comprising polyethylene terephthalate, post-consumer recycled grade polyethylene terephthalate, and a filler; and
a heat-sealable layer disposed on at least one surface of the core layer and comprising a co-polyester composition;
wherein:
the co-polyester composition of the heat-sealable layer comprises:
terephthalic acid, dimethyl terephthalate or a combination thereof;
at least one diol selected from the group consisting of mono ethylene glycol, diethylene glycol, triethylene glycol, 1,3-propanediol, 1,4-butanediol, neopentyl glycol, hexamethylene glycol, and cyclohexanedimethanol; and
isophthalic acid;
wherein the biaxially-oriented ultra-heat sealable polyester film exhibits a seal strength greater than 800 gmf/inch when sealed at 140° C. for 1 second at 4 kg/cm² of pressure.

2. The biaxially-oriented ultra-heat sealable polyester film as claimed in claim 1, wherein the film has at least two layers.

3. The biaxially-oriented ultra-heat sealable polyester film as claimed in claim 1, wherein the heat-sealable co-polyester comprises:
(a) 35 to 75% by weight of terephthalic acid, dimethyl terephthalate or a combination thereof;
(b) 25 to 40% by weight of at least one diol selected from the group consisting of mono ethylene glycol, diethylene glycol, triethylene glycol, 1,3-propanediol, 1,4-butanediol, neopentyl glycol, hexamethylene glycol, and cyclohexanedimethanol; and
(c) 10 to 30% by weight of isophthalic acid.

4. The biaxially-oriented ultra-heat sealable polyester film as claimed in claim 1, wherein the core layer mixture comprises:
(i) 40 to 80% by weight of polyethylene terephthalate polyester;
(ii) 0 to 30% by weight of modified polyethylene terephthalate polyester which is a fiber-grade polyester;
(iii) 20 to 100% by weight of post-consumer recycled polyethylene terephthalate; and
(iv) 0.05 to 0.1% by weight of silica.

5. The biaxially-oriented ultra-heat sealable polyester film as claimed in claim 4, wherein the polyethylene terephthalate polyester of the core layer mixture comprises 70 to 80% by weight of terephthalic acid, 22 to 30% by weight of mono ethylene glycol, and 0.5 to 5% by weight of diethylene glycol.

6. The biaxially-oriented ultra-heat sealable polyester film as claimed in claim 4, wherein the fiber-grade polyester of the core layer mixture comprises 68 to 85% by weight of terephthalic acid, 20 to 30% by weight of mono ethylene glycol, and 2 to 10% by weight of diethylene glycol.

7. The biaxially-oriented ultra-heat sealable polyester film as claimed in claim 1 having a total thickness of from 15 μm to 50 μm, wherein the core layer makes up from 50% to 80% of the total thickness of the film.

8. The biaxially-oriented ultra-heat sealable polyester film as claimed in claim 1 having one of more of:
a seal strength of 800 gmf/inch to 4500 gmf/inch when sealed at 140° C. for 1 second at 4 kg/cm² of pressure;
a total thickness of 15 μm to 50 μm, wherein the core layer makes up from about 50% to about 80% of the total thickness of the film;
a shrinkage, measured according to ASTM D1204, of about 2% or less in each of longitudinal and width directions after treatment with hot air at 150° C. for 30 min;
a puncture resistance, measured according to ASTM F1306 of about 5.5 N or greater;
a tensile strength at break, measured according to ASTM D882, of 1300 kg/cm² to 1900 kg/cm²; and
an elongation at break, measured according to ASTM D882, of 100 kg/cm² to 160 kg/cm².

9. The biaxially-oriented ultra-heat sealable polyester film as claimed in claim 1 wherein the film has water vapor transmission rate in the range of 0.30 to 45 g/m²-day, and oxygen transfer rate in the range of 0.40 to 100 cc/m²-day.

10. The biaxially oriented ultra-heat sealable polyester film as claimed in claim 1, further comprising one or more of a sealant layer, a printing layer, a metal layer, a barrier layer, an adhesive layer, a coating layer, a primer layer, and a protective layer.

11. A multilayer high-barrier film comprising the biaxially-oriented ultra-heat sealable polyester film as claimed in claim 1 with a barrier layer disposed on at least one of the one or more of the core layers; wherein the barrier layer comprises at least one of ethylene vinyl alcohol copolymers, polyvinyl alcohol polymers and copolymers, or polyvinylidene dichloride, aluminum, silicon oxide, and aluminum oxide; and wherein the film is unprinted or reverse-printed.

12. The multilayer high-barrier film as claimed in claim 11, wherein the film has water vapor transmission rate in the range of 0.20 to 0.40 g/m²-day, and oxygen transfer rate in the range of 0.20 to 0.50 cc/m²-day.

13. A co-polyester composition comprising:
a first polymer composition comprising pure terephthalic acid, ethylene glycol, and isophthalic acid; and
a second polymer composition comprising pure terephthalic acid, ethylene glycol, and neopentyl glycol;
wherein the weight ratio of the first polymer composition to the second polymer composition is in the range of 70:30.

14. A process for preparing a biaxially-oriented ultra-heat sealable polyethylene terephthalate film comprising:
preparing a core layer mixture comprising polyethylene terephthalate, modified polyethylene terephthalate, post-consumer recycled polyester and a filler, wherein the modified polyethylene terephthalate comprises fiber-grade polyester;
preparing a heat-sealable layer mixture comprising a heat-sealable co-polyester;
charging the core layer mixture to a main extruder to obtain a molten first mixture;
charging the heat-sealable layer mixture to a sub-extruder to obtain a molten second mixture;
extruding the molten first mixture and the molten second mixture through a die to provide an unstretched film; and
biaxially stretching the unstretched film under preheating conditions and heat-treating said film to a temperature of from 250° C. to 290° C., such that the stretch ratio in the longitudinal direction is from 3 to 3.6 times based on the original length of the unstretched film, and the stretch ratio in the transverse direction is from 3.2 to 4.5 times based on the original width of the unstretched film;
cooling the stretched film to obtain a biaxially-oriented ultra-heat-sealable polyethylene terephthalate film;
wherein a heat-sealing temperature of the biaxially-oriented ultra-heat-sealable polyethylene terephthalate film is 100° C. to 200° C.

15. The process as claimed in claim 14, wherein the biaxially-oriented ultra-heat sealable polyethylene terephthalate film has at least two layers.

16. The process as claimed in claim 14, wherein preparing the heat-sealable layer mixture comprises:
charging in a reactor terephthalic acid, dimethyl terephthalate or a combination thereof with at least one diol and isophthalic acid to obtain a reaction mixture;
subjecting the reaction mixture to an esterification reaction at a temperature of 240° C. to 270° C. to obtain an esterified prepolymer;
charging the esterified prepolymer to a polycondensation reactor and adding one or more polycondensation catalyst selected from silica, antimony compounds and magnesium compounds;
subjecting the prepolymer to a polycondensation reaction at a temperature in the range of 270° C. to 310° C. to obtain a molten amorphous polymer;
cooling and processing the molten polymer to form chips or pellets; and
optionally subjecting the resultant chips to solid state polymerization, to obtain a heat-sealable layer mixture comprising a heat-sealable co-polyester having an intrinsic viscosity greater than 0.65 dL/g.

17. The process as claimed in claim 14, wherein the heat-sealable co-polyester comprises:
35 to 70% by weight of terephthalic acid, dimethyl terephthalate, or a combination thereof;
21 wt. % to 40 wt. % of mono ethylene glycol, diethylene glycol, triethylene glycol, 1,3-propanediol, 1,4-butanediol, neopentyl glycol, hexamethylene glycol, cyclohexanedimethanol, or a mixture of any two or more thereof; and
10 wt. % to 30 wt. % isophthalic acid.

18. The process as claimed in claim 14,
wherein the core layer mixture comprises:
40 wt. % to 80 wt. % polyethylene terephthalate polyester;
0 wt. % to 30 wt. % fiber-grade polyester;
20 wt. % to 100 wt. % post-consumer recycled polyethylene terephthalate; and
0.05 wt. % to 0.1 wt. % silica.

19. The process as claimed in claim 14, wherein the polyethylene terephthalate polyester of the core layer mixture comprises 70 wt. % to 85 wt. % terephthalic acid, 20 wt. % to 30 wt. % mono ethylene glycol, and 0.5 wt. % to 5 wt. % diethylene glycol.

20. The process as claimed in claim 14, wherein the fiber-grade polyester of the core layer mixture comprises 65 wt. % to 85 wt. % terephthalic acid, 20 wt. % to 30 wt. % mono ethylene glycol, and 2 wt. % to 10 wt. % diethylene glycol.

21. The process as claimed in claim 14 further comprising passing the molten first mixture and the molten second mixture through a filter.

22. The process as claimed in claim 14 further comprising laminating the molten first mixture and the molten second mixture together in a feed-block to produce a laminated molten structure in the extrusion die.

23. The process as claimed in claim 14, wherein the processing comprises subjecting the extruded structure to one or more steps of preheating, stretching, and cooling.

24. The process as claimed in claim 23, wherein the stretching is conducted sequentially or simultaneously in the machine direction and the transverse direction.

25. The process as claimed in claim 23, wherein the preheating, stretching and cooling comprises machine direction preheating, stretching, and cooling followed by transverse direction preheating, stretching, and cooling.

26. The process as claimed in claim 25, wherein the preheating conditions comprise passing the unstretched film through a machine direction preheating zone at a temperature of 70° C. to 90° C., stretching the preheated structure in a longitudinal direction, and passing the longitudinally stretched film through a machine direction cooling zone at a temperature of 70° C. to 90° C.

27. The process as claimed in claim 26 further comprising passing the cooled longitudinally stretched film through a transverse direction preheating zone at a temperature of 92° C. to 110° C., stretching the preheated film in a transverse direction, and passing the transversely stretched film through a machine direction cooling zone at a temperature of 60° C. to 85° C.

28. The process as claimed in claim 14 further comprising adding an additional layer to the biaxially-oriented ultra-heat sealable polyester film.

29. The process as claimed in claim 28, wherein the additional layer comprises one or more of a sealant layer, a printing layer, a metal layer, a barrier layer, an adhesive layer, a coating layer, a primer layer, and a protective layer.

30. A packaging material comprising the biaxially-oriented ultra-heat sealable polyester film produced by the process as claimed in claim 14.

31. A packaging material comprising the biaxially-oriented ultra-heat sealable polyester film as claimed in claim 1.

32. The packaging material as claimed in claim 30, wherein the film is a food grade packaging film or medical products packaging film.

33. (canceled)

34. (canceled)

35. A process for the preparation of a heat-sealable co-polyester composition, the process comprising:
charging in a reactor terephthalic acid, dimethyl terephthalate or a combination thereof with at least one diol and isophthalic acid to obtain a reaction mixture;
subjecting the reaction mixture to an esterification reaction at a temperature of 240° C. to 270° C. to obtain an esterified prepolymer;
charging the prepolymer to a polycondensation reactor and adding one or more polycondensation catalyst selected from silica, antimony compounds and magnesium compounds;
subjecting the prepolymer to a polycondensation reaction at a temperature in the range of 270° C. to 310° C. to obtain a molten amorphous polymer;
crystallizing the amorphous polymer at a temperature in the range of 110° C. to 170° C. to obtain chips or pellets with a crystallinity of about 40% or more; and
optionally subjecting the chips or pellets to solid state polymerization, to obtain a heat-sealable layer mixture comprising a heat-sealable co-polyester having an intrinsic viscosity greater than 0.65 dL/g.

36. The process as claimed in claim 14, wherein the co-polyester composition comprises a first polymer composition comprising pure terephthalic acid, ethylene glycol, and isophthalic acid, and a second polymer composition comprising pure terephthalic acid, ethylene glycol, and neopentyl glycol, wherein the weight ratio of the first polymer composition to the second polymer composition is in the range of 70:30.
